(19) United States
(12) Patent Application Publication
(10) Pub. No.: US 2004/0126575 A1
(43) Pub. Date: Jul. 1, 2004

(54) Pressure-sensitive adhesive sheet, method for producing the same and method for using the same as well as a multi-layer sheet for use in the pressure-sensitive adhesive sheet and method for producing the same

(75) Inventors: Yoshinori Yoshida, Osaka (JP); Yohei Maeno, Osaka (JP); Kouji Akazawa, Osaka (JP); Takeshi Matsumura, Osaka (JP); Tomokazu Takahashi, Osaka (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 10/625,527

(22) Filed: Jul. 24, 2003

(30) Foreign Application Priority Data
Jul. 26, 2002 (JP) 2002-218553
Jul. 26, 2002 (JP) 2002-218554
Jul. 26, 2002 (JP) 2002-218555

(51) Int. Cl. B05D 5/10; B32B 7/12

(52) U.S. Cl. 428/343; 428/354; 427/207.1

(57) ABSTRACT

Disclosed is a pressure-sensitive adhesive sheet for use in processing a product such a semiconductor wafer. To provide a pressure-sensitive adhesive sheet that provides a minimized number of broken semiconductor wafers during the process of polishing them and that produces a less curl of the wafer due to the residual stress of the pressure-sensitive adhesive sheet, the pressure-sensitive adhesive sheet includes a composite film formed from a composition containing a urethane polymer and a vinyl polymer as effective components, a first film comprising a material different from that of the composite film, and a pressure-sensitive adhesive layer, in which the pressure-sensitive adhesive sheet has a modulus of 9 N/mm² or more and 250 N/mm² or less when an oblong piece of the pressure-sensitive adhesive sheet with a width of 20 mm is bent at a radius of curvature of 3.0 mm.

### BACKGROUND OF THE INVENTION

1. Field of the Invention

The present invention relates to a pressure-sensitive adhesive sheet, a method for producing the same and a method for processing a product using the same as well as a multi-layer sheet for use in such a pressure-sensitive adhesive sheet and a method for producing the same. In particular, the present invention relates to a pressure-sensitive adhesive sheet that is used for holding or protecting a product during the process of precision processing a semiconductor product such as a semiconductor wafer composed of silicon, gallium arsenide or the like or an optical product and to a multi-layer sheet that is used as a support such a pressure-sensitive adhesive sheet and a method for producing the same.

2. Description of a Related Art

In optical industries and semiconductor industries, pressure-sensitive adhesive sheets are used when optical parts such as lenses and semiconductor products such as semiconductor wafers are precision processed.

For example, in the process of producing semiconductor chips, a semiconductor wafer having formed thereon a predetermined circuit pattern such as an IC circuit is polished on the backside thereof so as to have a predetermined thickness and then transported to a dicing step in order to cut it into individual chips. The semiconductor wafer in itself is thin and brittle and the semiconductor wafer having the circuit pattern has unevenness of the surface, the semiconductor wafer tends to be broken if an external force is applied thereto while it is transported to a polishing step or dicing step. Also, during the polishing/processing step, the polishing treatment is performed while washing the backside of the wafer with purified water in order to remove polishing debris formed or remove the heat generated during the polishing and it is necessary to prevent the wafer from being contaminated by the polishing water or the like. For this purpose, to protect the circuit pattern surface and the like and prevent the breakage of the semiconductor wafer, it has been a routine in the art that a pressure-sensitive adhesive sheet is applied to the circuit pattern surface of a semiconductor wafer before the operation is performed and after completion of the operation the wafer is peeled off and recovered from the pressure-sensitive adhesive sheet. On this occasion, as the pressure-sensitive adhesive sheet, there have been known pressure-sensitive adhesive sheets that include a base material sheet comprised by, for example, polyethylene terephathalate (PET), polyethylene (PE), polypropylene (PP), ethylene/vinyl acetate copolymer (EVA) or the like, having a pressure-sensitive adhesive layer thereon.

Further, for example, JP-A 61-10242 discloses a film for use in processing a silicon wafer, which film includes a base material sheet having a Shore D hardness of 40 or less having a pressure-sensitive adhesive layer on one surface thereof. Also, JP-A 9-253964 discloses a pressure-sensitive adhesive tape that includes a base material comprised by a radiation-cured blend of a urethane acrylate oligomer and a reactive diluting monomer and a pressure-sensitive adhesive layer provided therewith. JP-A 61-260629 discloses a film for use in processing a silicon wafer that includes a base material film having a Shore D hardness of 40 or less laminated on one surface thereof with an auxiliary film having a Shore D hardness of greater than 40 and a pressure-sensitive adhesive layer on the other surface of the base material film.

However, in recent years, semiconductor wafers have an increasing difference in height of the unevenness in the thickness of the circuit pattern surface thereof and along with the downsizing of chips, semiconductor wafers have been required to have a reduced thickness of as thin as 100 μm or less. For example, in the case of pressure-sensitive adhesive sheets with a rigid base material such as PET, the curl of the wafer after polishing to a thin film can be restricted but the pressure-sensitive adhesive sheet cannot follow up the unevenness of the circuit pattern on the surface of the wafer so that the adhesion between the pressure-sensitive adhesive layer and the pattern surface becomes insufficient, thereby causing peeling of the sheet to occur or penetration of polishing water or foreign matter onto the pattern surface at the time of processing the wafer. On the other hand, in the case of a pressure-sensitive adhesive sheet with a flexible base material such as EVA, there is no problem in the following up of the pattern surface by the pressure-sensitive adhesive sheet but there occurs a curl after the polishing of the wafer or sag under the own weight of the wafer as the base material is insufficient in rigidity. Accordingly, it may be conceived to use a base material composed of a rigid base material PET and a flexible base material EVA plied to each other. However, when such different base materials are mechanically applied to each other through an adhesive, the stress given upon the application remains in the film resulting in curling of the base material. On the other hand, in the case where a laminate is formed by a T-die method or by a calendaring method, it is difficult to obtain a thick film, so that heat shrinkage upon film formation will cause a residual stress to occur in the film. The pressure-sensitive adhesive sheet with a base material in which a residual stress has occurred as described above causes a problem that there occurs breakage of a wafer and a curl in the wafer while the wafer is being polished. In addition, when a laminate is formed by a solution coating method, use of solvents may cause the problem of environmental pollution. Furthermore, to obtain a thick film, it has been necessary to repeat coating.

Therefore, pressure-sensitive adhesive sheets having a conventional base material or laminate as a base material are unsatisfactory for transporting or protecting such semiconductor wafers.

### SUMMARY OF THE INVENTION

Under the circumstances, the present invention has been made and has for its object to provide a pressure-sensitive adhesive sheet that for example, when in use in the process of processing products such as semiconductor wafers, provides a minimized number of semiconductor wafers during the process of polishing them even when the wafers are thin in thickness, that makes the sag of the semiconductor wafer small, and that produces a less curl of the wafer due to the residual stress of the pressure-sensitive adhesive sheet and a method for producing such a pressure-sensitive adhesive sheet as well as a multi-layer sheet for use in such a pressure-sensitive adhesive sheet and a method for producing such a multi-layer sheet.

To achieve the above-mentioned object, the pressure-sensitive adhesive sheet of the present invention comprises a composite film comprised by a composition containing a urethane polymer and a vinyl polymer as effective components, a first film comprising a material different from that of the composite film, and a pressure-sensitive adhesive layer, wherein the pressure-sensitive adhesive sheet has a modulus of 9 N/mm² or more and 250 N/mm² or less when an oblong piece of the pressure-sensitive adhesive sheet with a width of 20 mm is bent at a radius of curvature of 3.0 mm.

Here, the pressure-sensitive adhesive sheet may have a modulus of 15 N/mm² or more and 250 N/mm² or less when an oblong piece of the pressure-sensitive adhesive sheet with a width of 20 mm is bent at a radius of curvature of 3.0 mm.

The vinyl polymer may be an acrylic polymer.

The composite film may comprise a film obtained by reacting a polyol and a polyisocyanate in a radical polymerizable monomer to form a urethane polymer, coating a mixture of the urethane polymer and the radical polymerizable monomer on the first layer and irradiating a radiation onto the coating to cure it.

The radical polymerizable monomer may be an acrylic monomer.

The composite film may have a storage modulus at 25° C. of less than 2.0×10⁸ Pa and a storage modulus at 100° C. of 3.0×10⁵ Pa or more.

The first filmmayhave a storagemodulus at 25° C. of 2.0×10⁸ Pa or more.

The first film may have a thickness (t1) of 10 μm to 200 μm and the composite film may have a thickness (t2) of 10 μm to 300 μm. In this case, the ratio of the thicknesses (t1/t2) may be t1/t2=0.1 to 10.

The multi-player sheet for use in a pressure-sensitive adhesive sheet comprises a composite film comprised by a composition containing a urethane polymer and a vinyl polymer as effective components, and a first film comprising a material different from that of the composite film, wherein the pressure-sensitive adhesive sheet has a modulus of 9 N/mm² or more and 250 N/mm² or less when an oblong piece of the pressure-sensitive adhesive sheet with a width of 20 mm is bent at a radius of curvature of 3.0 mm.

The multi-layer sheet may comprise a second film on another side of the composite film.

The method for producing a pressure-sensitive adhesive sheet according to the present invention comprises coating a mixture containing a urethane polymer and a radiation polymerizable monomer on a first film, irradiating a radiation onto the coating to cure it to form a composite film, and forming a pressure-sensitive adhesive layer on the composite film.

The mixture may be produced by reacting a polyol and a polyisocyanate in the radical polymerizable monomer to form a urethane polymer.

The method for producing a multi-layer sheet according to the present invention comprises coating a mixture of a urethane polymer and a radical polymerizable monomer on a first film and irradiating a radiation onto the coating to cure it to form a composite film.

After the mixture is coated on the first film, a second film may be overlaid thereon and the radiation may be irradiated above the second film to cure the coating to form a composite film, thereby forming a multi-layer sheet having the first film, the composite film and the second film.

The mixture may be produced by reacting a polyol and a polyisocyanate in the radical polymerizable monomer to form a urethane polymer.

The method may comprise reacting a polyol and a polyisocyanate in the radical polymerizable monomer to form a urethane polymer, coating a mixture containing the urethane polymer and the radical polymerizable monomer on a base material, irradiating a radiation onto the coating to cure it to form on one side of the first layer a composite film having a storage modulus at 25° C. of less than 2.0×10⁸ Pa and a storage modulus at 100° C. of 3.0×10⁵ Pa or more.

The method for processing a product according to the present invention comprises applying either one of the pressure-sensitive adhesive sheet described above to a product to be precision processed and conducting precision processing of the product in a held and/or protected state.

The above and other objects, effects, features and advantages of the present invention will become more apparent from the detailed description to follow taken in conjunction with the accompanying drawings.

### BRIEF DESCRIPTION OF THE DRAWINGS

FIG. 1A is a cross-sectional view showing the construction of a multi-layer according to a first embodiment of the present invention;

FIG. 1B is a cross-sectional view showing the construction of a multi-layer sheet according to a second embodiment of the present invention;

FIG. 2A is a cross-sectional view showing the construction of a pressure-sensitive adhesive sheet according to a first embodiment of the present invention;

FIG. 2B is a cross-sectional view showing the construction of a pressure-sensitive adhesive sheet according to a second embodiment of the present invention;

FIG. 2C is a cross-sectional view showing the construction of a pressure-sensitive adhesive sheet according to a third embodiment of the present invention; and

FIG. 3 is a schematic diagram illustrating a method for measuring the repulsive force of a pressure-sensitive adhesive sheet.

### DETAILED DESCRIPTION OF THE INVENTION

The pressure-sensitive adhesive sheet of the present invention has a pressure-sensitive adhesive layer on a support. The support has thereon a composite film containing a urethane polymer and a vinyl polymer as effective components. The support includes, for example, a multi-layer sheet composed of a laminate of the composite film and a film made of a material different from that of the composite film and a multi-layer sheet composed of a laminate of the composite film and two or more films made of a material different from that of the composite film.

It should be noted that according to the definition of Japan Industrial Standard (JIS), usually the term “sheet” means a thin product generally having a relatively small thickness as compared with the length and width thereof and the term “film” means a thin, flat product having a relatively extremely small thickness as compared with the length and width, with its maximal thickness being optionally limited and usually provided in the form of a roll (Japan Industrial Standard JIS K-6900). Therefore, among sheets, those having particularly small thicknesses can be said to be films. However, there is no clear-cut boundary between a sheet and a film and they cannot be clearly distinguished one from another, so that in the present application, these are used interchangeably. That is, a “sheet” may also include a “film” and conversely a “film” may also include a “sheet”.

Hereinafter, the present invention will be described in detail with reference to the attached drawings. It should be noted that the same or like constitutional elements are designated by the same reference numeral and detailed description thereof will be omitted.

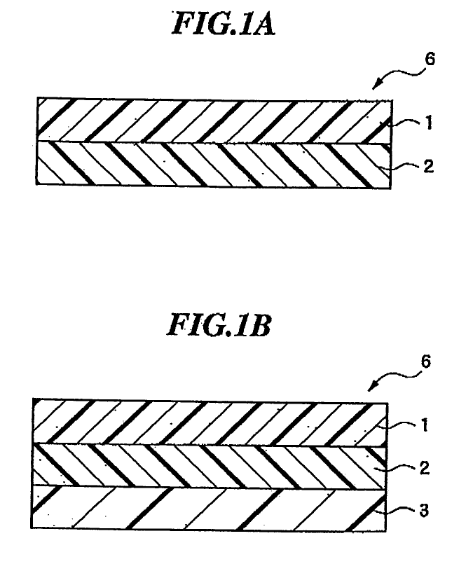

First, a multi-layer sheet used as a support for the pressure-sensitive adhesive sheet of the present invention will be described. FIG. 1A is a cross-sectional view showing the layer construction of a multi-layer sheet according to a first embodiment of the present invention. The multi-layer sheet shown in FIG. 1A includes a first film 1 that is laminated on a composite film 2, the first film 1 being made of a material that is different from the material of the composite film 2.

For the first film are used, for example, thermoplastic resins including polyester resins such as polyethylene terephthalate (PET); polyolefin resins such as polyethylene (PE) and polypropylene (PP); polyimides (PI); polyether ether ketones (PEEK), polyvinyl chloride resins (PVC); polyvinylidene chloride resins; polyamide resins; polyurethane resins; polystyrene resins; acrylic resins; fluororesins; cellulose resins; polycarbonate resins; and thermosetting resins. Among these preferred is PET because it has an appropriate hardness when it is used in processing precision parts. In addition, it is preferably used since it is advantageous from the viewpoints of abundance of species and of cost. It is preferred that the kind of the material that forms the first film be determined appropriately depending on the purpose and the kind of the pressure-sensitive adhesive layer to be provided. For example, in the case where the pressure-sensitive adhesive layer is an ultra-violet curing type pressure-sensitive adhesive layer, the first film preferably has a high ultraviolet transmittance and it is preferable that a material that can form such a first film be selected. It should be noted that the first film may be either a single layer or a laminate consisting of two layers or more. In the case of a laminate, it may be either a laminate composed of a plurality of layers made of the same kind of a material or a laminate composed of a plurality of layers made of different materials.

To the first film may optionally be added those additives usually used in amounts in the range where the effect of the present invention is not hindered. Examples of such additives include antioxidants, fillers, pigments, colorants, flame-retardants, antistatic agents, and ultraviolet absorbents.

It is preferable that the first film has a storage modulus at 25° C. of 2.0×10⁸ Pa or more, more preferably 2.0×10⁸ Pa or more and 1.0×10¹⁰ Pa or less, particularly preferably 1.0×10⁹ Pa or more and 1.0×10¹ Pa or less. If the storage modulus at 25° C. of less than 2.0×10⁸ Pa, performing processing of a semiconductor wafer with a pressure-sensitive adhesive sheet containing the first film causes a sag to occur in the semiconductor wafer, so that in some instances the semiconductor wafer may be broken during its transportation. When the first film has a storage modulus at 25° C. of 1.0×10¹⁰ Pa or less, it will never become difficult to cut a pressure-sensitive adhesive sheet in compliance with the form of a semiconductor wafer.

As used herein, the term “storage modulus” means a value obtained by cutting an object to be measured (for example, the first film or the like) to a size of about 50 mm×about 5 mm, and measuring the obtained sample by a dynamic thermomechanical measurement method on a viscoelasticity measuring apparatus (“DMS 6100”, a trade name, manufactured by Seiko Instruments Co., Ltd.) under the conditions of a tensile mode, a frequency of 1 Hz, a temperature elevation rate of 5° C./minute, a temperature region of from −100° C. to +200° C., and a sample size of 30 mm (length)×5 mm (width).

In the embodiment shown in FIG. 1A, the multi-layer sheet has a composite film on one side of the first film. The composite film is formed from a composition containing a urethane polymer and a vinyl polymer as effective components.

In the present invention, the composite film can be obtained, for example, by solution polymerization or emulsion polymerization of a vinyl monomer in the presence of a urethane polymer. The vinyl polymer that constitutes the composite film is preferably an acrylic polymer. In this case, solution polymerization or the like of the acrylic comonomer can form the urethane/acrylic composite material.

In the present invention, the composite film may be formed by forming a urethane polymer in a radical polymerizable monomer that serves as a diluent, coating a mixture based on the radical polymerizable monomer and the urethane polymer on a first film or the like, and irradiating a radiation onto the coating to cure it. On this occasion a radical polymerizable monomer having an unsaturated double bond, such as a vinyl monomer, as the radical polymerizable monomer is used. From the viewpoint of reactivity, acrylic monomers are preferable.

Specifically, urethane/acrylic composite materials for the composite film used in the present invention maybe obtained by the following methods.

(a) Reacting a polyol and a diisocyanate, dissolving the reaction product in an acrylic monomer to adjust its viscosity, coating the resultant solution on a base material, and then curing the coating by using a low-pressure mercury lamp or the like can provide a urethane/acrylic composite material.

(b) Also, a urethane/acrylic composite material can be obtained by dissolving a polyol in an acrylic monomer, reacting a diisocyanate with the mixture to adjust its viscosity, coating the obtained solution on a base material, and curing the coating by using a low-pressure mercury lamp or the like. In this method, the acrylic monomer may be added either in one time during the urethane synthesis or portionwise in plural times. Further, the polyol may be reacted after the diisocyanate is dissolved in the acrylic monomer.

Here, the method (a) has a disadvantage that when the molecular weight of the polyurethane produced by the reaction between the polyol and the diisocyanate increases, it becomes difficult to dissolve the polyurethane in the acrylic monomer, which naturally limits the molecular weight of the polyurethane produced. On the other hand, according to the method (b), a high molecular weight polyurethane can be produced without its molecular weight being limited, making it possible to design the molecular weight of the finally obtained polyurethane to a desired size.

(c) A urethane/acrylic composite material can be obtained by dissolving a urethane polymer in an acrylic monomer in advance, coating the solution on a base material and curing the coating by using a low-pressure mercury lamp or the like.

Examples of acrylic monomers preferably used in the present invention include (meth)acrylic acid, methyl (meth)acrylate, ethyl (meth)acrylate, propyl (meth)acrylate, butyl (meth)acrylate, pentyl (meth)acrylate, hexyl (meth)acrylate, 2-ethylhexyl (meth)acrylate, octyl (meth)acrylate, isooctyl (meth)acrylate, nonyl (meth)acrylate, isononyl (meth)acrylate, and isobornyl (meth)acrylate. Together with these esters, monomers having carboxyl groups such as maleic acid and itaconic acid and monomers having hydroxyl groups such as 2-hydroxyethyl acrylate, 2-hydroxyethyl methacrylate, 4-hydroxybutyl (meth)acrylate, and 6-hydroxyhexyl (meth)acrylate may be used.

Further, one or more monomers selected from vinyl acetate, vinyl propionate, styrene, acrylamide, methacrylamide, maleic acid mono- or diester and derivatives thereof, N-methylolacrylamide, glycidyl acrylate, glycidyl methacrylate, N,N-dimethylaminoethyl acrylate, N,N-dimethylaminopropyl methacrylamide, 2-hydroxypropyl acrylate, acryloylmorpholine, N,N-dimethylacrylamide, N,N-diethylacrylamide, imidoacrylate, N-vinylpyrrolidone, oligoester acrylate, -caprolactone acrylate, dicyclopentanyl (meth) acrylate, dicyclopentenyl (meth) acrylate, methoxylated cyclododecatriene acrylate, methoxyethyl acrylate and the like monomers may be copolymerized with the acrylic monomer used in the present invention. It should be noted that the kind and use amount of the monomers to be copolymerized may be appropriately determined taking the characteristics of the composite film and so forth into consideration.

In the present invention, polyfunctional monomers such as trimethylolpropane triacrylate and dipentaerythritol hexaacrylate may be used as crosslinking agents as needed. These monomers are also included by the radical polymerizable monomer according to the present invention.

The kind, combination, use amount and so forth of these radical polymerizable monomers may be appropriately determined taking into consideration their compatibility with the polyurethane, polymerizability upon photocuring with a radiation or the like and the characteristics of the obtained polymer.

The urethane polymer can be obtained by reacting a polyol and a polyisocyanate. In the reaction between the isocyanate and hydroxyl groups of the polyol, a catalyst may be used. For example, those catalysts generally employed in urethane reactions, such as dibutyltin dilaurate, tin octoate, and 1,4-diazabicyclo[2,2,2]octane may be used.

The polyol is preferably one that has two or more hydroxyl groups in the molecule. Examples of low molecular weight polyol include dihydric alcohols such as ethylene glycol, diethylene glycol, propylene glycol, butylene glycol and hexamethylene glycol, trihydric alcohols such as trimethylolpropane and glycerol and tetrahydric alcohols such as pentaerythritol.

On the other hand, examples of high molecular weight polyol include polyether polyols obtained by addition of ethylene oxide, propylene oxide, tetrahydrofuran or the like, polyester polyols composed of polycondensation products between the above-mentioned dihydric alcohol, such as dipropylene glycol, 1,4-butanediol or 1,6-hexanediol, or alcohol such as neopentyl glycol and a dibasic acid such as adipic acid, azelaic acid or sebacic acid, or acrylic polyols, carbonate polyols, epoxy polyols, and caprolactone polyols. Among these preferred are polyether polyols and polyester polyols. The acrylic polyols include besides copolymers of hydroxyl group-containing monomers such as hydroxyethyl (meth)acrylate and hydroxypropyl (meth)acrylate, copolymers of hydroxyl group-containing substance with an acrylic monomer. The epoxy polyols include, for example, amine-modified epoxy resins.

The polyols may be used singly or in combination. When the urethane/acrylic composite material is required to have an increased strength, it is effective to introduce a crosslinking structure with a triol or increase the amount of urethane hard segment with a low molecular weight diol. When an importance is laid on elongation of the urethane/acrylic composite material, it is preferable that a diol having a large molecular weight be used singly. Further, it should be noted that polyether polyols generally are cheap and have good durability and polyester polyols have a high strength. In the present invention, the kind and amount of polyol can be freely selected depending on the utility and purpose and also, the kind, molecular weight and use amount of the polyol can be appropriately selected from the viewpoint of urethane reactivity and compatibility with acryl monomers.

The polyisocyanate includes aromatic, aliphatic and alicyclic diisocyanates, dimmers, trimers and so forth of the diisocyanates. Specific examples of the aromatic, aliphatic and alicyclic diisocyanates include tolylene diisocyanate, diphenylmethane diisocyanate, hexamethylene diisocyanate, xylylene diisocyanate, hydrogenated xylylene diisocyanate, isophorone diisocyanate, hydrogenated diphenylmethane diisocyanate, 1,5-naphthylene diisocyanate, 1,3-phenylene diisocyanate, 1,4-phenylene diisocyanate, butane-1,4-diisocyanate, 2,2,4-trimethylhexamethylene diisocyanate, 2,4,4-trimethylhexamethylene diisocyanate, cyclohexane-1,4-diisocyanate, dicyclohexylemthane-4,4-diisocyanate, 1,3-bis(isocyanatomethyl)cyclohexane, methylcyclohexane diisocyanate, and m-tetramethylxylylene diisocyanate. Also, dimmers, trimers, and so forth of these as well as polyphenylmethane polyisocyanates may be used. As the trimers, there may be mentioned of isocyanurate type, biuret type and allophanate type trimers. These may be used appropriately.

These polyisocyanates may be used singly or in combination. From the viewpoints of urethane reactivity and compatibility with acrylic monomers, the kind, combination and so forth of the polyisocyanates may be properly selected.

In the present invention, the use amounts of the polyol component and the polyisocyanate component used for preparing the urethane polymer are not particularly limited. For example, the use amount of the polyol component is preferably such that NCO/OH (equivalent ratio) with respect to the polyisocyanate is 0.8 or more, and more preferably 0.8 or more and 3.0 or less. If the NCO/OH ratio is less than 0.8, the molecular chain length of the urethane polymer cannot be extended satisfactorily, so that the film strength and elongation tend to be decreased. On the other hand, if the NCO/OH ratio is 3.0 or less, the flexibility of the film can be sufficiently secured.

To the composite film may be optionally added those additives usually used, for example, ultraviolet absorbents, antioxidants, fillers, pigments, colorants, flame retardants, antistatic agents in amounts within the range where the effect of the present invention is not hindered. These additives are used in usually employed amounts depending on their kind. These additives may be added in advance prior to the polymerization reaction between the polyisocyanate and the polyol or may be added prior to the polymerization between the urethane polymer and the reactive monomer.

Further, to adjust the viscosity of the coating composition upon coating, a small amount of a solvent may be added to the coating composition. The solvent may be appropriately selected from those solvents usually employed for the purpose. Examples of such a solvent include ethyl acetate, toluene, chloroform, and dimethylformamide.

In the present invention, as described above, a composite film can be formed, for example, by reacting a polyol and a polyisocyanate in a radical polymerizable monomer, coating a mixture of the urethane polymer and the radical polymerizable monomer on, for example, a first film, and irradiating an ionized radiation such as α-ray, β-ray, γ-ray, neutron ray, or electron beam, radiation such as ultraviolet rays, visible light or the like to photocure the coating.

On this occasion, to prevent the inhibition of polymerization by oxygen, a release-treated sheet may be placed on the mixture of the urethane polymer and radical polymerizable monomer coated on the first film to block oxygen. Alternatively, the oxygen concentration in the atmosphere can be decreased by introducing the composite film into a vessel filled with an inert gas.

In the present invention, the kind of radiation or the like and the kind of the lamp to be used for irradiation of radiation and so forth may be selected appropriately and for example, low-pressure lamps such as a fluorescent chemical lamp, a black light, and a sterilizing lamp, high-pressure lamps such as a metal halide lamp and a high-pressure mercury lamp may be used.

The dose of ultraviolet rays and the like may be set optionally depending on the required characteristics of the film. Generally, the dose of ultraviolet rays is 100 mJ/cm² or more and 5,000 mJ/cm² or less, preferably 1,000 mJ/cm² or more and 4,000 mJ/cm² or less, and more preferably 2,000 mJ/cm² or more and 3,000 mJ/cm² or less. If the dose of ultraviolet rays is less than 100 mJ/cm², no sufficient polymerization degree can be obtained in some cases. On the other hand, the dose of ultraviolet rays beyond 5,000 mJ/cm² may cause deterioration of the film.

Further, the temperature at the time of irradiation with ultraviolet rays is not particularly limited and may be optionally set. If the temperature is too high, there tends to occur a termination reaction due to heat of polymerization, thus causing deterioration of the characteristics of the film. Therefore, the temperature upon irradiation with violet rays is usually 70° C. or lower, preferably 50° C. or lower, and more preferably 30° C. or lower.

The mixture based on the urethane polymer and radical polymerizable monomer contains a photopolymerization initiator. As the photopolymerization initiator, benzoin ethers such as benzoin methyl ether and benzoin isopropyl ether, substituted benzoin ethers such as anisole methyl ether, substituted acetophenones such as 2,2-diethoxyacetophenone and 2,2-dimethoxy-2-phenylacetophenone, substituted α-ketol such as 1-hydroxycyclohexyl phenyl ketone and 2-methyl-2-hydroxypropiophenone, aromatic sulfonyl chlorides such as 2-naphethalenesulfonyl chloride, optically active oximes such as 1-phenyl-1,1-propanedion-2-(o-ethoxycarbonyl)-oxime are preferably used.

In the present invention, it is particularly desirable that a photopolymerization initiator having a hydroxyl group in the molecule be used. Upon formation of the urethane polymer by reacting the polyol and the polyisocyanate, copresence of a photopolymerization initiator having a hydroxyl group in the molecule enables incorporation of the photopolymerization initiator in the urethane polymer. This can produce a urethane/acrylic block copolymer at the time of irradiation with radiation to cure. It is presumed that this effect can improve elongation and strength of the film.

It is preferable that the composite film has a storage modulus at 25° C. of less than 2.0×10⁸ Pa, more preferably 3.0×10⁵ Pa or more and less than 2.0×10⁸ Pa, and particularly preferably 1.0×10⁶ Pa or more and 1.0×10⁸ Pa or less. Further, the composite film has a storage modulus at 100° C. of preferably 3.0×10⁵ Pa or more, more preferably 3.0×10⁵ Pa or more and less than 2.0×10⁸ Pa, and particularly preferably 1.0×10⁶ Pa or more and 1.0×10⁸ Pa or less. Since the multi-layer sheet having a composite film with a storage modulus at 25° C. of 2.0×10⁸ Pa or more has a high rigidity of the sheet so that when a product such as a semiconductor wafer is polished with a pressure-sensitive adhesive sheet containing the multi-layer sheet, the product may be broken during the polishing step. A temperature of composite film tends to be increased by heat generated during polishing a semiconductor wafer to a thin wafer, a modulus of the composite film decreases, so that if the multi-layer sheet has a composite film with a storage modulus at 100° C. of less than 3.0×10⁵ Pa, a capability of the multi-layer sheet to hold the semiconductor wafer drops and the semiconductor wafer may be broken.

Proper selection of the composition of the urethane polymer, the kind and composition of the vinyl polymer, blending ratios of the urethane polymer and the vinyl polymer and so forth and proper combination of a crosslinking agent and the like can provide composite films having various storage moduli.

When the composite film formed from the resin mixture containing the urethane polymer and the vinyl polymer as effective components is laminated onto the first film having a high storage modulus, the product to be processed such as a semiconductor wafer shows a minimized flexure or curl due to the interaction between the first layer and cohesion by the urethane bonds constituting the urethane polymer or the interaction between the urethane bonds and the ester bonds of the vinyl polymer even when it is small in thickness. In addition, such an interaction minimizes a decrease in the storage modulus at 100° C. of the composite film, thereby minimizing a decrease in the capability of the film to hold the semiconductor wafer.

The multi-layer sheet of the present invention may have a film laminated on another side of the composite film. FIG. 1B shows such an embodiment. FIG. 1B is a cross-sectional view showing the layer construction of a multi-layer sheet according to a second embodiment of the present invention. The multi-layer sheet shown in FIG. 1B has a first film 1 laminated on a composite film 2 and a second film 3 laminated on another side of the composite film 2.

The second film laminated on another side of the composite film may be a film made of the same material as that of the first film or may be a film made of a different material from that of the first film. The film made of a different material from that of the first film may include the same materials as those listed for the first film and may be properly selected therefrom.

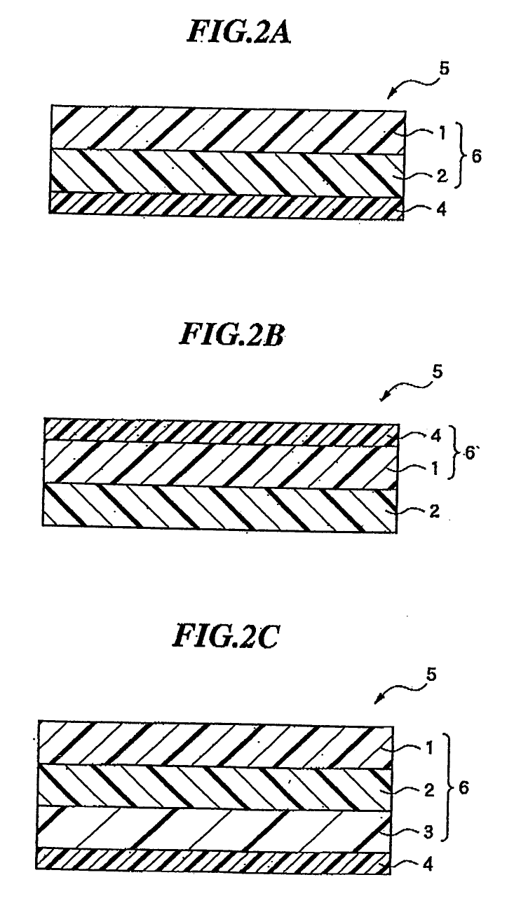

The multi-layer sheet of the present invention can be formed of a pressure-sensitive adhesive layer to provide a pressure-sensitive adhesive sheet. An embodiment of the pressure-sensitive adhesive sheet of the present invention will be explained concretely with reference to FIGS. 2A to 2C. Here, both the case where the multi-layer sheet of the present invention shown in FIG. 1A is formed of a pressure-sensitive adhesive layer and the where the multi-layer sheet of the present invention shown in FIG. 1B is formed of a pressure-sensitive adhesive layer will be explained.

FIG. 2A is a cross-sectional view showing the layer construction of a pressure-sensitive adhesive sheet according to a first embodiment of the present invention. The pressure-sensitive adhesive sheet shown in FIG. 2A includes a multi-layer sheet composed of a laminate of a first film 1 and a composite film 2 having a pressure-sensitive adhesive layer 4 formed on the side of the composite film 2. On the other hand, the pressure-sensitive adhesive sheet shown in FIG. 2B has the pressure-sensitive adhesive layer 4 formed on the side of the first film 1. As described above, in the present invention, a pressure-sensitive adhesive layer may be formed on either side of the multi-layer sheet to make a pressure-sensitive adhesive sheet. However, it is preferable that the pressure-sensitive adhesive layer be formed on the side of the composite film. The pressure-sensitive adhesive sheet shown in FIG. 2C has the first film 1 on one side of the composite film 2 and the second film 3 on the other side of the composite film, in which a pressure-sensitive adhesive layer is formed on the side of the second film.

The pressure-sensitive adhesive layer must have adhesive strength suitable for securely holding a product such as a semiconductor wafer while the product is being processed and an adhesion strength that allows readily release of the product or the like without loads after completion of the processing. For this purpose, it is preferable that the pressure-sensitive adhesive layer when it is released after completion of processing should have a 180° peel adhesive strength in the range of 0.01 N/20 mm to 1 N/20 mm. The composition of the pressure-sensitive adhesive that constitutes such a pressure-sensitive adhesive layer is not particularly limited and known pressure-sensitive adhesives used for bond-fixing semiconductor wafers and other products may be used. For example, rubber-based pressure-sensitive adhesives containing a natural rubber or a rubber-based polymer such as a styrene copolymer as a base polymer, silicone-based pressure-sensitive adhesives, acrylic-based pressure-sensitive adhesives, polyvinyl ether-based pressure-sensitive adhesives, and so forth may be used. Among these preferred from the viewpoints of adhesion to semiconductor wafers, washability of semiconductor wafers after release with ultrapure water or organic solvents such as alcohols are acrylic-based pressure-sensitive adhesives containing acrylic-based polymers as base polymers.

The acrylic-based polymer includes, for example, acrylic-based polymers obtained by polymerizing one or more monomer components selected from alkyl (meth)acrylates (for example, esters of a linear or branched chain alkyl having 1 to 30 carbon atoms, in particular 4 to 18 carbon atoms, such as methyl, ethyl, propyl, isopropyl, butyl, isobutyl, s-butyl, t-butyl, pentyl, isopentyl, hexyl, heptyl, octyl, 2-ethylhexyl, isooctyl, nonyl, decyl, isodecyl, undecyl, dodecyl, tridecyl, tetradecyl, hexadecyl, octadecyl and eicosyl) and cycloalkyl (meth)acrylates (for example, cyclopentyl ester, cyclohexyl ester and so forth). It should be noted that the term “(meth)acrylate” means acrylate and/or methacrylate and “(meth)” as used herein has a similar meaning to that described above in all the cases.

To modify its cohesion, heat resistance and so forth, the acrylic-based polymer may contain units corresponding to other monomer components that are copolymerizable with the (meth)acrylates or cycloalkyls described above. Examples of the monomer component include carboxyl group-containing monomers such as acrylic acid, methacrylic acid, carboxyethyl (meth)acrylate, carboxypentyl (meth)acrylate, itaconic acid, maleic acid, fumaric acid and crotonic acid; acid anhydride monomers such as maleic anhydride and itaconic anhydride; hydroxyl group-containing monomers such as 2-hydroxyethyl (meth)acrylate, 2-hydroxypropyl (meth)acrylate, 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and (4-hydroxymethylcyclohexyl)methyl (meth)acrylate; sulfonate group-containing monomers such as styrenesulfonic acid, allyl sulfonate, 2-(meth)acrylamide-2-methylpropanesulfonic acid, (meth)acrylamidopropanesulfonic acid, sulfopropyl (meth)acrylate and (meth)acryloyloxynaphthalenesulfonic acid; phosphate group-containing monomers such as 2-hydroxyethylacryloyl phosphate; acrylamide, acrylonitrile and so forth. The copolymerizable monomer components may be used singly or as combinations of two or more of them. The use amount of these copolymerizable monomers is preferably 40 wt& or less of the total weight of the monomer components.

Further, the acrylic-based polymer may contain a polyfunctional monomer and so forth for crosslinking. Examples of such a polyfunctional monomer include hexanediol di(meth)acrylate, (poly) ethylene glycol di (meth) acrylate, (poly)propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy (meth)acrylate, polyester (meth)acrylate, urethane (meth)acrylate, and so forth. These polyfunctional monomers may also be used singly or as combinations of two or more of them. The use amount of the polyfunctional monomers is preferably 30 wt % or less based on the total weight of the monomer components.

The polymerization method for forming the acrylic-based polymer may be any method selected from solution polymerization, emulsion polymerization, bulk polymerization, suspension polymerization and so forth. The pressure-sensitive adhesive layer preferably contains a small amount of low molecular weight substances so that the side where a product such as a semiconductor wafer is applied to should not be contaminated. From this viewpoint, the acrylic-based polymer preferably has a number average molecular weight of about 300,000 or more and more preferably about 400,000 to about 3,000,000.

To increase the number average molecular weight of the acrylic-based polymer, polyisocyanate compounds, epoxy compounds, aziridine compounds, melamine crosslinking agents and the like may be added. The use amount of the additives may be properly determined depending on the balance with the base polymer to be crosslinked and further on the application to which the acrylic-based polymer as a pressure-sensitive adhesive is used. Generally, it is preferable that about 1 to about 5 parts by weight of the additive per 100 pars by weight of the base polymer is blended. Further, the pressure-sensitive adhesive may optionally contain besides the above-mentioned components various kinds of conventionally known additives such as tackifiers and antioxidants.

In the present invention, it is preferable that a pressure-sensitive adhesive of the radiation-curing type be used as a pressure-sensitive adhesive. The pressure-sensitive adhesive of the radiation-curing type can be obtained, for example, by compounding a pressure-sensitive adhesive substance with an oligomer component that forms a low adhesive substance upon irradiation of a radiation or the like thereto to cure it. When the pressure-sensitive adhesive layer is formed from a pressure-sensitive adhesive of the radiation-curing type, the oligomer component contained the pressure-sensitive adhesive gives plastic flowability upon application of a sheet with such a pressure-sensitive adhesive layer, so that the sheet can be readily applied to a desired object. On the other hand, when the sheet is to be released, the sheet is readily released from a product such a semiconductor wafer since irradiation of a radiation to the pressure-sensitive adhesive forms a low adhesive substance.

As the pressure-sensitive adhesive of the radiation-curing type, there can be used those pressure-sensitive adhesives having a radiation curable functional group such as a carbon-to-carbon double bond in the molecule and exhibiting adhesiveness. For example, an addition type radiation-curing type pressure-sensitive adhesive comprised by a common pressure-sensitive adhesive to which a radiation-curing type monomer component or an oligomer component is blended and an internal type radiation-curing type pressure-sensitive adhesive comprised by a base polymer having a carbon-to-carbon double bond in the end of main chain or main chain of the polymer can be used. The radiation used for curing the pressure-sensitive adhesive layer includes, for example, X-rays, electron beams, and ultraviolet rays. From the viewpoint of readiness of handling, it is preferable to use ultraviolet rays. However, the present invention is not limited thereto.

As the common pressure-sensitive adhesive that constitutes the addition type radiation-curing type pressure-sensitive adhesive can be used pressure-sensitive adhesives such as the above-mentioned acrylic pressure-sensitive adhesives and rubber-based pressure-sensitive adhesives.

Examples of the monomer having a radiation-curing type functional group include urethane oligomer, urethane (meth)acrylate, trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxy penta(meth)acrylate, dipentaerythritol hexa(meth)acrylate, and 1,4-butanediol di(meth)acrylate. On the other hand, radiation-curing type oligomer component includes various oligomers such as urethane-, polyether-, polyester-, polycarbonate- and polybutadiene-based oligomers. Those oligomers having a molecular weight in the range of about 100 to about 30,000 are suitable. The compounding amount of the monomer component or oligomer component having a radiation-curing type functional group is, for example, preferably 5 to 500 parts by weight, more preferably about 40 to about 150 parts by weight based on 100 parts by weight of the base polymer such as an acrylic polymer.

The internal type radiation-curing type pressure-sensitive adhesive does not have to and often does not contain the oligomer component or the like, which is a component of low polymerization degree, so that there does not occur a situation that the oligomer component or the like migrates in the pressure-sensitive adhesive. As a result, a pressure-sensitive adhesive layer having a stable layer structure can be formed.

In the internal type radiation-curing type pressure-sensitive adhesive, those polymers that have a carbon-to-carbon double bond and exhibit adhesiveness can be used as base polymers without particular limitations. Such base polymers preferably have a basic skeleton made of an acrylic polymer. The acrylic polymer used here may include the same polymers as those acrylic polymers that have already been exemplified in the explanation for acrylic-based pressure-sensitive adhesives.

The method for introducing a carbon-to-carbon double bond to the acrylic-based polymer as a basic skeleton is not particularly limited and various methods may be used without limitations. In the present invention, it is preferable to introduce a carbon-to-carbon double bond to a side chain of the acrylic-based polymer to form a base polymer having a carbon-to-carbon double bond since molecular design is facilitated thereby. Specifically, this is done, for example, as follows. After a monomer having a functional group is preliminarily copolymerized with an acrylic polymer, a compound having both a functional group that can react with the functional group of the monomer and carbon-to-carbon double bond can be condensed or added to the copolymer while maintaining the radiation-curing type of the carbon-to-carbon double bond to introduce the carbon-to-carbon double bond into a side chain of the acrylic polymer.

Examples of combination of the functional group of monomer to be copolymerized with the acrylic polymer and a functional group that car react with the functional group of the monomer are shown below. For example, combinations of a carboxylate group and an epoxy group; a carboxylate group and an aziridyl group; and a hydroxyl group and an isocyanate group are preferable. Among these combinations, the combination of hydrocyl group and an isocyanete group, since it facilitates following up the reaction. Further, in the combination of the functional groups, any functional group may be present on the side of the acrylic-based polymer. For example, in the combination of a hydroxyl group and an isocyanate group, it is preferable that the acrylic-based polymer has a hydroxyl group and the compound having a functional group that can react with the functional group, i.e., the hydroxyl group, has an isocyanate group. In this case, the compound having an isocyanate group includes, for example, methacryloyl isocyanate, 2-methacryloyloxyethyl isocyanate, and m-isopropenyl-α,α-dimethylbenzyl isocyanate. On the other hand, the acrylic-based polymer having a functional group (i.e., a hydroxyl group) includes, for example, copolymers obtained by copolymerizing the hydroxyl group-containing monomers that have been already exemplified in the explanation of the acrylic-based pressure-sensitive adhesive, 2-hydroxyethyl vinyl ether-based compounds, 4-hydroxybutyl vinyl ether-based compounds, diethylene glycol monovinyl ether-based compounds and the like with the acrylic-based polymer.

The base polymer having a carbon-to-carbon double bond alone may be used for the internal type radiation-curing type pressure-sensitive adhesive. However, the above-mentioned radiation-curing type monomer component and oligomer component may also be compounded with the base polymer having a carbon-to-carbon double bond so far as they do not deteriorate the characteristics of the adhesive. The compounding amount of the radiation-curing type oligomer component or the like is usually 30 parts by weight or less, preferably in the range of 0 to 10 parts by weight based on 100 parts by weight of the base polymer.

When the above-mentioned radiation-curing type pressure-sensitive adhesive is cured with ultraviolet rays or the like, a photopolymerization initiator is added to the pressure-sensitive adhesive. Examples of the photopolymerization initiator include α-ketol compounds such as 4-(2-hydroxyethoxy)phenyl (2-hydroxy-2-propyl) ketone, α-hydroxy-α,α′-dimethylacetophenone, 2-methyl-2-hydroxypropiophenone, 1-hydroxycyclohexyl phenyl ketone, and acetophenon compounds such as methoxyacetophenon,2,2-dimethoxy-2-phenyl acetophenon, 2,2-diethoxy acetophenon, 2-methyl-1-[4-(methylthio)phenyl]-2-morpholinopropane-1; benzoin ether compounds such as benzoin ethyl ether, benzoin isopropyl ether, and anisoin methyl ether; ketal compounds such as benzyl dimethyl ketal; aromatic sulfonyl chloride compounds such as 2-naphthalenesulfonyl chloride; optically active oxime compounds such as 1-phenone-1,1-propanedione-2-(o-ethoxycarbonyl) oxime; benzophenone compounds such as benzophenone, benzoyl benzoate, and 3,3′-dimethyl-4-methoxybenzophenone; thioxanthone compounds such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, and 2,4-diisopropylthioxanthone; camphor quinone, halogenated ketone, acylphosphinoxide, acyl phosphonate and so forth. The compounding amount of the photopolymerization initiator include is, for example, about 1 to about 10 parts by weight, preferably about 3 to about 5 parts by weight based on 100 parts by weight of the base polymer such as acrylic-based polymer.

In the present invention, the pressure-sensitive adhesive layer may be formed by coating the above-mentioned pressure-sensitive adhesive together with solvents as needed directly on a substrate such as composite film or the like. Alternatively, the pressure-sensitive adhesive layer may be formed by coating the pressure-sensitive adhesive on a release liner to form a pressure-sensitive adhesive layer in advance and then applying the pressure-sensitive adhesive layer onto the composite film or the like.

The thickness of the pressure-sensitive adhesive layer is not particularly limited and may be optionally set. Usually, the thickness of the pressure-sensitive adhesive layer is preferably 3 μm or more and 100 μm or less and more preferably 10 μm or more and 30 μm or less. The thicknesses of the first and second films and the thickness of the composite film in the pressure-sensitive adhesive sheet of the present invention may be properly selected depending on the purpose taking, for example, flexural modulus into consideration. In particular, when the pressure-sensitive adhesive sheet of the present invention is used for processing precision parts, the composite film has a thickness of preferably about 10 μm or more and about 300 μm or less and more preferably about 50 μm or more and about 250 μm or less. The first film has a thickness of preferably about 10 μm or more and about 300 μm or less and more preferably about 30 μm or more and about 200 μm or less. The second film has a thickness of preferably about 10 μm or more and about 300 μm or less and more preferably about 30 μm or more and about 200 μm or less.

Generally, it is preferable that the thickness of the first film (t1) is in the range of 10 to 200 μm and the thickness of the composite film (t2) is in the range of 10 to 300 μm. It is also preferable that a thickness ratio, i.e., a ratio of the thickness of the first film to the thickness of the composite film (t1/t2) is in the range of 0.1 to 10. If the thickness ratio (t1/t2) is less than 0.1, a modulus of the pressure-sensitive adhesive sheet decreases and a capability of the sheet to held the wafers drops, so that the wafers may be broken. On the other hand, if the thickness ratio (t1/t2) is greater than 10, the rigidity of the pressure-sensitive adhesive sheet becomes too high and it may be sometimes the case that products such as wafers are deteriorated during a polishing process.

The pressure-sensitive adhesive sheet of the present invention has a modulus (hereinafter, sometimes referred to also as “flexural modulus”) of 9 N/mm² or more, preferably 15 N/mm² or more, more preferably 20 N/mm² or more and particularly preferably 25 N/mm² or more when an oblong piece of the pressure-sensitive adhesive sheet with a width of 20 mm is bent at a radius of curvature of 3.0 mm. Also, under the same conditions, the flexural modulus of the pressure-sensitive adhesive sheet is 250 N/mm² or less, preferably 200 N/mm² or less and more preferably 150 N/mm² or less. If the flexural modulus of the pressure-sensitive adhesive sheet is less than 9 N/mm², sometimes the curl of a wafer cannot be maintained within an allowance when the wafer is polished to a thin wafer. As a result, a problem may occur when the wafer is transported. On the other hand, if the flexural modulus of the pressure-sensitive adhesive sheet is 250 N/mm² or less, the pressure-sensitive adhesive sheet can satisfactorily follow up the unevenness of a pattern surface of a wafer and the pressure-sensitive adhesive sheet can be readily peeled off from the wafer by applying a sheet for releasing to the pressure-sensitive adhesive sheet and then drawing the sheet for releasing.

In the present invention, proper combination of the kind of the materials of the first film and of the composite film and the kind of the material of the second film and the like that is laminated on the composite film as needed can give a pressure-sensitive adhesive sheet having a desired flexural modulus.

In the present invention, flexural modulus of an object is obtained by making the object have a shape of a width of 20 mm and a length of about 50 mm, bending this in the longitudinal direction so as to have a radius of curvature of 3.0 mm, and measuring a repulsive force of the object, followed by calculation of the obtained data according to the following equation (1):

E=(2R²/wh³)·M (1)

In the equation described above, E is flexural modulus (unit: N/mm²), R is a radius of curvature (unit: mm), w is a width of an object (sample to be measured) (unit: mm), h is a thickness of the object (sample to be measured) (unit: mm) and M is a repulsive force (unit: g).

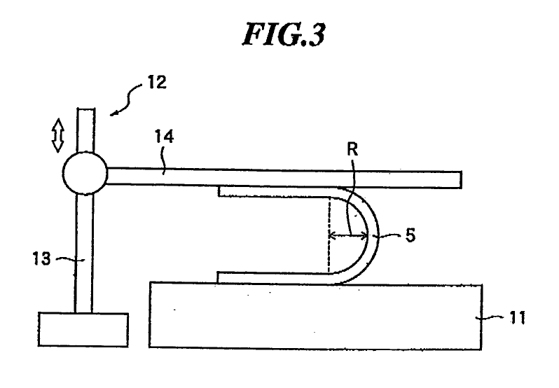

Now, referring to FIG. 3, the method of measuring a repulsive force of an object is described.

FIG. 3 is a diagram for illustrating a method of measuring a repulsive force of an object (here, a pressure-sensitive adhesive sheet 5 shown in FIGS. 2A to 2C). By the side of an electronic balance 11 is arranged a jig 12 that can bend a pressure-sensitive adhesive sheet 5 on the electronic balance 5. The jig 12 has a post 13 and a pressure bar 14 is supported by the post parallel to an upper side of the electronic balance 11 and is slidable along a longitudinal axis of the post so that it can move up and down along the support 13. The jig 12 is designed such that it is slided to a position at which a radius curvature, R, of the pressure-sensitive adhesive sheet when the pressure-sensitive adhesive sheet is bent in the longitudinal direction is 3.0 mm, that is, a position at which two sides of the pressure-sensitive adhesive sheet that are parallel to each other have a distance of 6.0 mm therebetween, thereby pushing the upper side of the bent pressure-sensitive adhesive sheet 5. The repulsive force of the pressure-sensitive adhesive sheet is measured at room temperature in a bent state such that an object with a width of 20 mm is bent so as to have a radius of curvature, R, of 3.0 mm. Specifically, the pressure-sensitive adhesive sheet 5 as a sample to be measured is cut to a piece having a size of a width of 20 mm and a length of 50 mm, which is mounted on the electronic balance 11. The sample is bent so as to have a radius of curvature, R, of 3.0 mm and then the jig 12 is set. The sample is kept in this state for 60 seconds and the numerical value (A) displayed on the electronic balance is read. The repulsive force of the pressure-sensitive adhesive sheet is obtained as follows. The repulsive force of the pressure-sensitive adhesive sheet is defined as a value (A−B) obtained by subtracting the weight of the sample (here, pressure-sensitive adhesive sheet 5) (B) from the measured value (A).

The pressure-sensitive adhesive sheet of the present invention is used according to a conventional method upon processing a product such as a semiconductor wafer. Here, an example of use of a pressure-sensitive adhesive sheet in polishing a rear surface of a semiconductor wafer is shown. First, a semiconductor wafer having a pattern such as an IC circuit is mounted on a table such that the patterned surface is up. Then, on the patterned surface is overlaid applied the pressure-sensitive adhesive sheet of the present invention so that its pressure-sensitive adhesive layer contacts the patterned surface of the semiconductor wafer and while pressing the pressure-sensitive adhesive sheet onto the wafer by a pressing means such as a press roll. Alternatively, a laminate of a semiconductor wafer and a pressure-sensitive adhesive sheet as described above is placed in a pressurizable container (for example, autoclave), and then the inside of the container is pressurized to bond the pressure-sensitive adhesive sheet to the semiconductor wafer. A pressing means may be used in combination with this. Further, a semiconductor wafer and a pressure-sensitive adhesive sheet may be bonded to each other either in a vacuum chamber or by heating the pressure-sensitive adhesive sheet at a temperature not higher than the melting point of the base material of the pressure-sensitive adhesive sheet.

As the method of polishing a rear surface of a semiconductor wafer, a conventional polishing method can be adopted. For example, the rear surface of a semiconductor wafer to which a pressure-sensitive adhesive sheet has been bonded is polished until a desired thickness of the semiconductor wafer is reached by using a polishing machine (back grind) as a processing machine for polishing and a pad for CMP (Chemical Mechanical Polishing). In the case where a pressure-sensitive adhesive sheet whose pressure-sensitive adhesive layer has been formed from a pressure-sensitive adhesive of the radiation-curing type, a radiation or the like is irradiated to the pressure-sensitive adhesive layer at the time when polishing is completed to decrease the adhesive strength of the pressure-sensitive adhesive layer and thereafter, the pressure-sensitive adhesive sheet is released.

### EXAMPLES

Hereinafter, the present invention will be described in more detail by way of examples. However, the present invention should not be considered to be limited thereto. It should be noted that in the following examples, all parts are by weight unless otherwise indicated specifically.

### Example I

### Example I-1

In a reactor equipped with a condenser, a thermometer, and a stirrer were charged 50.0 parts of t-butyl acrylate, 30.0 parts of acrylic acid, and 20.0 parts of butyl acrylate as an acrylic-based monomer, 1.0 part of trimethylolpropane triacrylate as a polyfunctional monomer, 0.1 part of 1-[4-(2-hydroxyethoxy)phenyl]-2-hydroxy-2-methyl-1-propan-1-one (trade name: “Irgacure 2959”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a 100-μm thick polyethylene terephthalate (PET) film to a thickness after curing of 100 μm. This coating was covered with a release-treated PET film (38 μm thick) and the PET film covering the coating was irradiated with ultraviolet rays (illuminance: 163 mW/cm²; quantity of light: 2,100 mJ/cm²) on the surface thereof by using a high-pressure mercury lamp to cure the coating to form a composite film as a film 3. Thereafter, the release-treated PET film covering the coating was released to obtain a PET film/composite film multi-layer sheet. Observation of the obtained multi-layer sheet with naked eye indicated no curl.

### Example I-2

In a reactor equipped with a condenser, a thermometer, and a stirrer were charged 117 parts of N,N-dimethylacrylamide and 117.0 parts of acrylic acid as an acrylic-based monomer, 0.1 part of 1-[4-(2-hydroxyethoxy)phenyl]-2-hydroxy-2-methyl-1-propan-1-one (trade name: “Irgacure 2959”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a 100-μm thick ethylene/vinyl acetate copolymer (EVA) film to a thickness after curing of 100 μm. This coating was covered with a release-treated PET film (38 μm thick) and a surface of the PET film covering the coating was irradiated with ultraviolet rays (illuminance: 163 mW/cm²; quantity of light: 2,100 mJ/cm²) by using a high-pressure mercury lamp to cure the coating to form a composite film as a film 3. Thereafter, the release-treated PET film covering the coating was released to obtain an EVA film/composite film multi-layer sheet. Observation of the obtained multi-layer sheet with naked eye indicated no curl.

### Example I-3

In the same manner as in Example I-1, a urethane polymer-acrylic-based monomer mixture was coated to a thickness of 100 μm on a 100-μm thick PET film. Then, this coating was covered with a 38-μm thick, release-non-treated PET film in place of the release-treated PET film and a surface of the PET film covering the coating was irradiated with ultraviolet rays (illuminance: 163 mW/cm²; quantity of light: 2,100 mJ/cm²) by using a high-pressure mercury lamp to cure the coating to form a composite film as a film 3 as shown in FIG. 1B. Thus, a multi-layer sheet of PET film/composite film/PET film was obtained. Observation of the obtained multi-layer sheet with naked eye indicated no curl.

### Example I-4

In the same manner as in Example I-2, a urethane polymer-acrylic-based monomer mixture was coated to a thickness of 100 μm on a 100-μm thick EVA film. Then, this coating was covered with a 38-μm thick, release-non-treated PET film in place of the release-treated PET film and a surface of the PET film covering the coating was irradiated with ultraviolet rays (illuminance: 163 mW/cm²; quantity of light: 2,100 mJ/cm²) by using a high-pressure mercury lamp to cure the coating to form a composite film as a film 3 as shown in FIG. 1B. Thus, a multi-layer sheet of EVA film/composite film/PET film was obtained. Observation of the obtained multi-layer sheet with naked eye indicated no curl.

### Comparative Example I-1

On a 100-μm thick EVA film was provided a 15-μm thick pressure-sensitive acrylic adhesive layer. On this pressure-sensitive adhesive layer was overlaid a 100-μm thick PET film and these were bonded to each other to obtain a laminate. The obtained laminate was a multi-layer sheet of EVA film/pressure-sensitive adhesive layer/PET film. Observation of the obtained multi-layer sheet with naked eye indicated occurrence of a curl.

<Evaluation Tests>

Multi-layer sheets obtained in Examples I-1 to I-4 and Comparative Example I-1 were each provided with a 30-μm thick pressure-sensitive adhesive layer on one side thereof to prepare respective pressure-sensitive adhesive sheets. The pressure-sensitive adhesive layer was formed as described below. That is, first, a blend of 78 parts of ethyl acrylate, 100 parts of butyl acrylate, and 40 parts of 2-hydroxyethyl acrylate was copolymerized in a toluene solution to obtain an acrylic-based copolymer having a number average molecular weight of 300,000. Subsequently, the acrylic-based copolymer was subjected to an addition reaction with 43 parts of 2-methacryloyloxyethyl isocyanate to introduce carbon-to-carbon double bonds in the molecular chain. Further, a mixture of 1 part of a polyisocyanate crosslinking agent and 3 parts of an acetophenones-based photopolymerization initiator per 100 parts of the obtained polymer was coated on one surface of the multi-layer sheet to form a 30-μm thick pressure-sensitive adhesive layer, thereby preparing a pressure-sensitive adhesive sheet. The pressure-sensitive adhesive sheet thus formed was measured of flexural modulus. Table 1 shows the results.

Next, twenty 8-inch wafers each having a thickness of 625 μm were provided and the pressure-sensitive adhesive sheets obtained as described above were bonded thereto by using “DR-8500III” manufactured by Nitto Seiki co., Ltd. The laminates were polished by using a silicon wafer-polishing machine manufactured by Disko Co., Ltd. to a thickness of 50 μm. The polished products were subjected to the following evaluations. Table 1 shows the results.

It should be noted that for comparison, the same evaluations were made on a 100-μm thick PET monolayer sheet and a 1000-μm thick EVA monolayer sheet as reference examples. Table 1 also shows the results of these evaluations.

(1) Evaluation of Curl

A silicon wafer after polishing of which the pressure-sensitive adhesive sheet remained to be bonded thereto was placed stationary on a plate with its pressure-sensitive adhesive sheet side up. Then, the distance of a part (usually a wafer edge) that was remotest from the surface of the plate was measured. An average of curls was obtained. Wafers having an average curl of 5 mm or less were satisfactory and wafers having an average curl of greater than 8 mm were faulty.

(2) Presence or Absence of Penetration of Water

Silicon wafers after polishing were released from pressure-sensitive adhesive sheets and the surface of each silicon wafer on which the pressure-sensitive adhesive sheet was bonded was observed under optical microscopes (two types; one with a magnification of 100 times and another with a magnification of 200 times). A case where penetration of water was observed even only one wafer out of 20 wafers was indicated that penetration of water was “present” and a case in where penetration of water was observed in none of the wafers was indicated that penetration of water was “absent”.

TABLE 1

| | Example | Example | Example | Example | Comparative | Reference | Reference |
|---|---|---|---|---|---|---|---|
| | I-1 | I-2 | I-3 | I-4 | Example I-1 | Example I-1 | Example I-2 |
| Film 1 | PET | EVA | PET | EVA | EVA | PET | EVA |
| Film 3 | Composite | Composite | Composite | Composite | Pressure- | — | — |
| | Film | Film | Film | Film | sensitive | | |
| | | | | | Adhesive | | |
| Film 2 | — | — | PET | PET | PET | — | — |
| Pressure-sensitive | Film 3 | Film 1 | Film 2 | Film 1 | Film 1 | Film 1 | Film 1 |
| Adhesive Surface* | | | | | | | |
| Flexural Modulus | 55.1 | 15.2 | 55.9 | 17.4 | 40.8 | 269.7 | 10.5 |

Evaluation

| | | | | | | | |
|---|---|---|---|---|---|---|---|
| Curl | 3 | 4 | 1 | 3 | 15 | 7 | 14 |
| Penetration | Absent | Absent | Absent | Absent | Absent | Present | Absent |
| of water | | | | | | | |

Note 1)
*Layer that contacted the pressure-sensitive adhesive surface when a pressure-sensitive adhesive sheet was prepared.
Note 2)
Unit of flexural modulus: N/mm²

As will be apparent from Table 1, silicon wafers processed by using the pressure-sensitive adhesive sheets prepared using the multi-layer sheets in Examples I-1 to I-4 of the invention had a curl of less than 5 mm. None of them showed penetration of neither water nor cracks when they were polished to a thickness of 50 μm.

On the other hand, in the case where silicon wafers processed to form thin films by using pressure-sensitive adhesive sheet having the laminate sheet of Comparative Example I-1 as a base material, a curl of the wafers was 15 mm or more and thus the wafers were difficult to handle. In Reference Example I-1 in which a pressure-sensitive adhesive sheet with a PET single film as a support was used for comparison, penetration of water was observed. On the other hand, in the case where the pressure-sensitive adhesive sheet of Reference Example I-2 with an EVA monolayer film as a support was used, no penetration of water was observed but the curl of the wafers was relatively large.

### Example II

### Example II-1

In a reactor equipped with a condenser, a thermometer, and a stirrer were charged 50.0 parts of t-butyl acrylate, 30.0 parts of acrylic acid, and 20.0 parts of butyl acrylate as an acrylic-based monomer, 0.1 part of 1-[4-(2-hydroxyethoxy)phenyl]-2-hydroxy-2-methyl-1-propan-1-one (trade name: “Irgacure 2959”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a 75-μm thick PET film to a thickness after curing of 100 μm. Onto a surface of this were irradiated ultraviolet rays (illuminance: 163 mW/cm²; quantity of light: 2,100 mJ/cm²) by using a high-pressure mercury lamp to cure the coating to form a composite film on the PET film to obtain a multi-layer sheet (support).

Then, a blend of 78 parts of ethyl acrylate, 100 parts of butyl acrylate, and 40 parts of 2-hydroxyethyl acrylate was copolymerized in a toluene solution to obtain an acrylic-based copolymer having a number average molecular weight of 300,000. Subsequently, the acrylic-based copolymer was subjected to an addition reaction with 43 parts of 2-methacryloyloxyethyl isocyanate to introduce carbon-to-carbon double bonds in a side chain in the molecule. Further, a mixture of 1 part of a polyisocyanate crosslinking agent and 3 parts of an acetophenones-based photopolymerization initiator per 100 parts of the obtained polymer was coated on one surface of the multi-layer sheet to form a 30-μm thick pressure-sensitive adhesive layer, thereby preparing a pressure-sensitive adhesive sheet. The pressure-sensitive adhesive sheet thus formed had a flexural modulus of 32.8 N/mm².

### Example II-2

The urethane polymer-acrylic-based monomer mixture prepared in Example II-1 was coated on a 100-μm thick PET film to a thickness after curing of 100 μm. Onto a surface of this were irradiated ultraviolet rays (illuminance: 163 mW/cm²; quantity of light: 2,100 mJ/cm²) by using a high-pressure mercury lamp to cure the coating to form a composite film on the PET film to obtain a multi-layer sheet.

Then, in the same manner as in Example II-1, a 30-μm thick pressure-sensitive adhesive layer was provided to prepare a pressure-sensitive adhesive sheet. The flexural modulus of the obtained pressure-sensitive adhesive sheet was 53.5 N/mm².

### Example II-3

In a reactor equipped with a condenser, a thermometer, and a stirrer were charged 50.0 parts of t-butyl acrylate, 30.0 parts of acryloylmorpholine, and 20.0 parts of acrylic acid as an acrylic-based monomer, 1.0 part of trimethylolpropane triacrylate as a polyfunctional monomer, 0.1 part of 1-[4-(2-hydroxyethoxy)phenyl]-2-hydroxy-2-methyl-1-propan-1-one (trade name: “Irgacure 2959”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a 75-μm thick PET film to a thickness after curing of 100 μm. Onto a surface of this were irradiated ultraviolet rays (illuminance: 163 mW/cm²; quantity of light: 2,100 mJ/cm²) by using a high-pressure mercury lamp to cure the coating to form a composite film on the PET film to obtain a multi-layer sheet.

Then, in the same manner as in Example II-1, a 30-μm thick pressure-sensitive adhesive layer was provided to prepare a pressure-sensitive adhesive sheet. The pressure-sensitive adhesive sheet thus formed had a flexural modulus of 71.2 N/mm².

### Example II-4

The urethane polymer-acrylic-based monomer mixture prepared in Example II-3 was coated on a 100-μm thick PET film to a thickness after curing of 100 μm. Onto a surface of this were irradiated ultraviolet rays (illuminance: 163 mW/cm²; quantity of light: 2,100 mJ/cm²) by using a high-pressure mercury lamp to cure the coating to form a composite film on the PET film to obtain a multi-layer sheet.

Then, in the same manner as in Example II-1, a 30-μm thick pressure-sensitive adhesive layer was provided to prepare a pressure-sensitive adhesive sheet. The flexural modulus of the obtained pressure-sensitive adhesive sheet was 109.2 N/mm².

### Example II-5

The urethane polymer-acrylic-based monomer mixture prepared in Example II-3 was coated on a 100-μm thick PET film to a thickness after curing of 25 μm. Onto a surface of this were irradiated ultraviolet rays (illuminance: 163 mW/cm²; quantity of light: 2,100 mJ/cm²) by using a high-pressure mercury lamp to cure the coating to form a composite film on the PET film to obtain a multi-layer sheet.

Then, in the same manner as in Example II-1, a 30-μm thick pressure-sensitive adhesive layer was provided to prepare a pressure-sensitive adhesive sheet. The flexural modulus of the obtained pressure-sensitive adhesive sheet was 174.7 N/mm².

### Comparative Example II-1

In a reactor equipped with a condenser, a thermometer, and a stirrer were charged 50.0 parts of t-butyl acrylate, 30.0 parts of acryloylmorpholine, and 20.0 parts of acrylic acid as an acrylic-based monomer, 1.0 part of trimethylolpropane triacrylate as a polyfunctional monomer, 0.1 part of 1-[4-(2-hydroxyethoxy)phenyl]-2-hydroxy-2-methyl-1-propan-1-one (trade name: “Irgacure 2959”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a release-treated surface of a PET film to a thickness after curing of 200 μm. Onto a surface of this were irradiated ultraviolet rays (illuminance: 163 mW/cm²; quantity of light: 2,100 mJ/cm²) by using a high-pressure mercury lamp to cure the coating to form a composite film on the PET film, followed by releasing and removing the release sheet to obtain a monolayer sheet of the composite film.

Then, in the same manner as in Example II-1, a 30-μm thick pressure-sensitive adhesive layer was provided to prepare a pressure-sensitive adhesive sheet. The pressure-sensitive adhesive sheet thus formed had a flexural modulus of 5.0 N/mm².

### Comparative Example II-2

In a reactor equipped with a condenser, a thermometer, and a stirrer were charged 100.0 parts of isobornyl acrylate as an acrylic-based monomer, 0.1 part of 1-[4-(2-hydroxyethoxy)phenyl]-2-hydroxy-2-methyl-1-propan-1-one (trade name: “Irgacure 2959”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a release-treated surface of a PET film to a thickness after curing of 200 μm. Onto a surface of this were irradiated ultraviolet rays (illuminance: 163 mW/cm²; quantity of light: 2,100 mJ/cm²) by using a high-pressure mercury lamp to cure the coating to form a composite film on the PET film, followed by releasing and removing the release sheet to obtain a monolayer sheet of the composite film.

Then, in the same manner as in Example II-1, a 30-μm thick pressure-sensitive adhesive layer was provided to prepare a pressure-sensitive adhesive sheet. The pressure-sensitive adhesive sheet thus formed had a flexural modulus of 6.2 N/mm².

### Comparative Example II-3

A 100-μm thick PET film was provided as a support. Then, in the same manner as in Example II-1, a 30-μm thick pressure-sensitive adhesive layer was provided to prepare a pressure-sensitive adhesive sheet. The pressure-sensitive adhesive sheet thus formed had a flexural modulus of 269.7 N/mm².

### Comparative Example II-4

A 175-μm thick ethylene/vinyl acetate copolymer (EVA) film was provided as a support. Then, in the same manner as in Example II-1, a 30-μm thick pressure-sensitive adhesive layer was provided to prepare a pressure-sensitive adhesive sheet. The pressure-sensitive adhesive sheet thus formed had a flexural modulus of 10.5 N/mm².

<Evaluation Tests>

The pressure-sensitive adhesive sheets obtained in Examples II-1 to II-5 and Comparative Examples II-1 to II-4 were actually used in polishing wafers and curl, releasability and penetration of water of the wafers were evaluated.

That is, first, twenty 8-inch wafers each having a thickness of 625 μm were provided and the pressure-sensitive adhesive sheets obtained as described above were bonded thereto by using “DR-8500III” manufactured by Nitto Seiki co., Ltd. The laminates were polished by using a silicon wafer-polishing machine manufactured by Disko Co., Ltd. to a thickness of 50 μm. The polished products were subjected to the following evaluations. Table 2 shows the results. It should be noted that when the silicon wafers were polished until a thickness of 50 μm was reached, number of wafers which showed voids was counted and the results are also shown in Table 2.

(1) Evaluation of Curl

A silicon wafer after polishing to a thickness of up to 50 μm of which the pressure-sensitive adhesive sheet remained to be bonded thereto was placed stationary on a plate with its pressure-sensitive adhesive sheet side up. Then, the distance between points at which the height of the wafer became maximal was measured as a curl. In this case, the curl was indicated in terms of an average of 20 wafers.

(2) Releasability

After polishing wafers, a weakly pressure-sensitive adhesive sheet was bonded to the rear side of a wafer to release and remove a pressure-sensitive adhesive sheet for processing from the wafer. On this occasion, the number of wafers of which cracks or voids are occurred was obtained as an average of the measured values of twenty wafers.

(3) Presence or Absence of Penetration of Water

Silicon wafers after polishing were released from pressure-sensitive adhesive sheets and the surface of each silicon wafer on which the pressure-sensitive adhesive sheet was bonded was observed under optical microscopes (two types; one with a magnification of 100 times and another with a magnification of 200 times). A case where penetration of water was observed even only one wafer out of 20 wafers was indicated that penetration of water was “present” and a case in where penetration of water was observed in none of the wafers was indicated that penetration of water was “absent”.

TABLE 2

| Example | | | | | Comparative Example | | | |
|---|---|---|---|---|---|---|---|---|
| II-1 | II-2 | II-3 | II-4 | II-5 | II-1 | II-2 | II-3 | II-4 |

Base
Material Film

| | | | | | | | | | |
|---|---|---|---|---|---|---|---|---|---|
| Material | PET | PET | PET | PET | PET | Urethane- | Urethane- | PET | EVA |
| | | | | | | Acrylic | Acrylic | | |
| Thickness (μm) | 75 | 100 | 75 | 100 | 100 | 200 | 200 | 100 | 175 |

Composite Film

| | | | | | | | | | |
|---|---|---|---|---|---|---|---|---|---|
| | Yes | Yes | Yes | Yes | Yes | No | No | No | No |
| Thickness (μm) | 100 | 100 | 100 | 100 | 25 | — | — | — | — |

Pressure-sensitive
Adhesive Layer

| | | | | | | | | | |
|---|---|---|---|---|---|---|---|---|---|
| Thickness (μm) | 30 | 30 | 30 | 30 | 30 | 30 | 30 | 30 | 30 |
| Thickness of | 205 | 230 | 205 | 230 | 155 | 230 | 230 | 130 | 205 |
| Pressure-sensitive | | | | | | | | | |
| Adhesive Sheet (μm) | | | | | | | | | |
| Flexural | 32.8 | 53.5 | 71.2 | 109.2 | 174.7 | 5.0 | 6.2 | 269.7 | 10.5 |
| Modulus (N/mm²) | | | | | | | | | |

Evaluation

| | | | | | | | | | |
|---|---|---|---|---|---|---|---|---|---|
| Curl (mm) | 3 | 2 | 2 | 1 | 5 | 15 | 12 | 7 | 14 |
| Releasability | 0 | 0 | 0 | 0 | 0 | 0 | 0 | 2 | 0 |
| (Number) | | | | | | | | | |
| Penetration | Absent | Absent | Absent | Absent | Absent | Absent | Absent | Present | Absent |
| of Water | | | | | | | | | |
| Wafer | 0 | 0 | 0 | 0 | 0 | 0 | 0 | 15 | 2 |
| Breakage (Number) | | | | | | | | | |

As will be apparent from Table 2, silicon wafers processed by using the pressure-sensitive adhesive sheets prepared using the multi-layer sheets in Examples II-1 to II-5 of the invention had a curl of 5 mm or less so that they could be readily housed in a housing cassette conventionally used, so that transportation operation, etc. are not hindered or no breakage occurred in the wafers. Further, when a pressure-sensitive adhesive sheet for processing was removed after completion of the processing, none the wafers showed cracks or voids. Further, none of the wafers showed penetration of water or cracks when they were polished to a thickness of 50 μm.

On the other hand, in the case where silicon wafers were processed to form thin films by using pressure-sensitive adhesive sheet of Comparative Examples II-1 and II-2 as well as Comparative Example II-4, a curl of the wafers was 10 mm or more and thus voids or other defects occurred in the wafers or transporting operation or the like was sometimes harmed. Further, when the pressure-sensitive adhesive sheet of Comparative Example II-3 that had a flexural modulus greater than 250 N/mm² was used, penetration of water was observed and the wafer was broken when the pressure-sensitive adhesive sheet was released.

### Example III

A mixture containing a urethane polymer and an acrylic-based monomer was prepared as follows.

<Preparation of a Mixture Containing a Urethane Polymer and an Acrylic-Based Monomer>

### (1) Synthesis Example 1

### Preparation of Mixture 1

In a reactor equipped with a condenser, a thermometer, and a stirrer were charged 75.0 parts of isobornyl acrylate and 25.0 parts of acrylic acid as an acrylic-based monomer, 0.1 part of 1-hydroxycyclohexyl phenyl ketone (trade name: “Irgacure 184”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a release-treated PET film (38 μm thick) to a thickness after curing of 100 μm. Onto a surface of this were irradiated ultraviolet rays (illuminance: 163 mW/cm²; quantity of light: 2,100 mJ/cm²) by using a high-pressure mercury lamp to cure the coating to prepare a composite film of urethane-acrylic composite film. The obtained composite film had a storage modulus at 25° C. of 3.8×10⁶ Pa and a storage modulus at 100° C. of 1.2×10⁶ Pa.

### (2) Synthesis Example 2

### Preparation of Mixture 2

In a reactor equipped with a condenser, a thermometer, and a stirrer were charged 75.0 parts of methyl acrylate and 75.0 parts of acrylic acid as an acrylic-based monomer, 0.15 part of 1-[4-(2-hydroxyethoxy)phenyl]-2-hydroxy-2-methyl-1-propan-1-one (trade name: “Irgacure 2959”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a release-treated PET film (38 μm thick) to a thickness after curing of 100 μm. Onto a surface of this were irradiated ultraviolet rays (illuminance: 163 mW/cm²; quantity of light: 2,100 mJ/cm²) by using a high-pressure mercury lamp to cure the coating to prepare a composite film of urethane-acrylic composite film. The obtained composite film had a storage modulus at 25° C. of 5.3×10⁶ Pa and a storage modulus at 100° C. of 1.9×10⁴ Pa.

### (3) Synthesis Example 3

### Preparation of Mixture 3

In a reactor equipped with a condenser, a thermometer, and a stirrer were charged 50.0 parts of t-butyl acrylate and 50.0 parts of acrylic acid as an acrylic-based monomer, 0.1 part of trimethylolpropane triacrylate as a polyfunctional monomer, 0.15 parts of 1-[4-(2-hydroxyethoxy)phenyl]-2-hydroxy-2-methyl-1-propan-1-one (trade name: “Irgacure 2959”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a release-treated PET film (38 μm thick) to a thickness after curing of 100 μm. Onto a surface of this were irradiated ultraviolet rays (illuminance: 163 mW/cm²; quantity of light: 2,100 mJ/cm²) by using a high-pressure mercury lamp to cure the coating to prepare a composite film of urethane-acrylic composite film. The obtained composite film had a storage modulus at 25° C. of 3.2×10⁶ Pa and a storage modulus at 100° C. of 1.9×10⁶ Pa.

### (4) Synthesis Example 4

### Preparation of Mixture 4

In a reactor equipped with a condenser, a thermometer, and a stirrer were charged 75.0 parts of butyl acrylate and 25.0 parts of acrylic acid as an acrylic-based monomer, 0.15 parts of 1-[4-(2-hydroxyethoxy)phenyl]-2-hydroxy-2-methyl-1-propan-1-one (trade name: “Irgacure 2959”, manufactured by Ciba Specialty Chemicals Co., Ltd.) as a photopolymerization initiator, 73.4 parts of polyoxytetramethylene glycol (molecular weight: 650; manufactured by Mitsubishi Chemical Corporation) as a polyol, and 0.05 part of dibutyltin dilaurate as a urethane reaction catalyst. While stirring, 26.6 parts of xylylene diisocyanate was dripped to the mixture and the mixture was allowed to react at 65° C. for 2 hours to obtain a urethane polymer-acrylic-based monomer mixture. It should be noted that the polyisocyanate component/polyol component ratio (NCO/OH equivalent ratio) was 1.25.

The urethane polymer-acrylic-based monomer mixture was coated on a release-treated PET film (38 μm thick) to a thickness after curing of 100 μm. Onto a surface of this were irradiated ultraviolet rays (illuminance: 163 mW/cm²; quantity of light: 2,100 mJ/cm²) by using a high-pressure mercury lamp to cure the coating to prepare a composite film of urethane-acrylic composite film. The obtained composite film had a storage modulus at 25° C. of 6.4×10⁵ Pa and a storage modulus at 100° C. of 2.3×10⁵ Pa.

### Example III-1

As first films were provided three kinds of films having different thicknesses, i.e., 50 μm, 100 μm and 150 μm as shown in Table 3. That is, polypropylene films having a storage modulus at 25° C. of 4.0×10⁹ Pa (thicknesses: 50 μm, 100 μm and 150 μm) were provided. On one surface of each polypropylene film was coated Mixture 1 composed of the urethane polymer and acrylic-based monomer obtained in Synthetic Example 1 to a thickness after curing of 50 μm, 100 μm or 150 μm as shown in Table 3 and cured by irradiating ultraviolet rays (illuminance: 163 mW/cm²; quantity of light: 2,100 mJ/cm²) by using a high-pressure mercury lamp to cure the coating to form a composite film on the first film to prepare a support having a layer structure of first film/composite film.

Then, a blend of 78 parts of ethyl acrylate, 100 parts of butyl acrylate, and 40 parts of 2-hydroxyethyl acrylate was copolymerized in a toluene solution to obtain an acrylic-based copolymer having a number average molecular weight of 300,000. Subsequently, the acrylic-based copolymer was subjected to an addition reaction with 43 parts of 2-methacryloyloxyethyl isocyanate to introduce carbon-to-carbon double bonds in the molecular chain. Further, a mixture of 1 part of a polyisocyanate crosslinking agent and 3 parts of an acetophenones-based photopolymerization initiator per 100 parts of the obtained polymer was coated on the surface of the composit film to form a 30-μm thick pressure-sensitive adhesive layer, thereby preparing a pressure-sensitive adhesive sheet.

### Example III-2

As supports were provided three kinds of PET films having different thicknesses, i.e., 50 μm, 100 μm and 150 μm as shown in Table 3. The PET films had a storage modulus at 25° C. of 7.2×10⁹ Pa. On one surface of each PET film was coated Mixture 2 composed of the urethane polymer and acrylic-based monomer obtained in Synthetic Example 2 to a thickness after curing of 50 μm, 100 μm or 150 μm as shown in Table 3 and cured by irradiating ultraviolet rays (illuminance: 163 mW/cm²; quantity of light: 2,100 mJ/cm²) by using a high-pressure mercury lamp to cure the coating to form a composite film on the PET film to prepare a support having a layer structure of first film/composite film.

Then, a blend of 78 parts of ethyl acrylate, 100 parts of butyl acrylate, and 40 parts of 2-hydroxyethyl acrylate was copolymerized in a toluene solution to obtain an acrylic-based copolymer having a number average molecular weight of 300,000. Subsequently, the acrylic-based copolymer was subjected to an addition reaction with 43 parts of 2-methacryloyloxyethyl isocyanate to introduce carbon-to-carbon double bonds in the molecular chain. Further, a mixture of 1 part of a polyisocyanate crosslinking agent and 3 parts of an acetophenones-based photopolymerization initiator per 100 parts of the obtained polymer was coated on one surface of the multi-layer sheet to form a 30-μm thick pressure-sensitive adhesive layer, thereby preparing a pressure-sensitive adhesive sheet.

### Example III-3

As first films were provided three kinds of PET films having different thicknesses, i.e., 50 μm, 100 μm and 150 μm as shown in Table 3. The PET films had a storage modulus at 25° C. of 7.2×10⁹ Pa. On one surface of each PET film was coated Mixture 3 composed of the urethane polymer and acrylic-based monomer obtained in Synthetic Example 3 to a thickness after curing of 50 μm, 100 μm or 150 μm as shown in Table 3 and cured by irradiating ultraviolet rays (illuminance: 163 mW/cm²; quantity of light: 2,100 mJ/cm²) by using a high-pressure mercury lamp to cure the coating to form a composite film on the PET film to prepare a support having a layer structure of first film/composite film.

Then, a blend of 78 parts of ethyl acrylate, 100 parts of butyl acrylate, and 40 parts of 2-hydroxyethyl acrylate was copolymerized in a toluene solution to obtain an acrylic-based copolymer having a number average molecular weight of 300,000. Subsequently, the acrylic-based copolymer was subjected to an addition reaction with 43 parts of 2-methacryloyloxyethyl isocyanate to introduce carbon-to-carbon double bonds in the molecular chain. Further, a mixture of 1 part of a polyisocyanate crosslinking agent and 3 parts of an acetophenones-based photopolymerization initiator per 100 parts of the obtained polymer was coated on one surface of the multi-layer sheet to form a 30-μm thick pressure-sensitive adhesive layer, thereby preparing a pressure-sensitive adhesive sheet.

### Comparative Example III-1

As first films were provided three kinds of PET films having different thicknesses (i.e., 50 μm, 100 μm and 150 μm) as shown in Table 4. The PET films had a storage modulus at 25° C. of 7.2×10⁹ Pa. On one surface of each PET film was coated a blend of 78 parts of ethyl acrylate, 100 parts of butyl acrylate, and 40 parts of 2-hydroxyethyl acrylate was copolymerized in a toluene solution to obtain an acrylic-based copolymer having a number average molecular weight of 300,000. Subsequently, the acrylic-based copolymer was subjected to an addition reaction with 43 parts of 2-methacryloyloxyethyl isocyanate to introduce carbon-to-carbon double bonds in the molecular chain. Further, a mixture of 1 part of a polyisocyanate crosslinking agent and 3 parts of an acetophenones-based photopolymerization initiator per 100 parts of the obtained polymer was coated on one surface of the multi-layer sheet to form a 30-μm thick pressure-sensitive adhesive layer, thereby preparing a pressure-sensitive adhesive sheet.

### Comparative Example III-2

As first films were provided three kinds of EVA films having different thicknesses (i.e., 50 μm, 100 μm and 150 μm) as shown in Table 4. The EVA films had a storage modulus at 25° C. of 9.5×10⁷ Pa. On one surface of each EVA film was coated the acrylic-based pressure-sensitive adhesive prepared in Example III-1 in the same manner as in Comparative Example III-1 to form a pressure-sensitive adhesive layer to prepare a pressure-sensitive adhesive sheet.

### Comparative Example III-3

As first films were provided three kinds of PET films having different thicknesses (i.e., 50 μm, 100 μm and 150 μm) as shown in Table 4. The PET firms had a storage modulus at 25° C. of 7.2×10⁹ Pa. On one surface of each PET film was provided a soft polyvinylchloride film layer by a T-die method (cf. Table 4: thicknesses; 50 μm, 100 μm and 150 μm). The flexible polyvinyl chloride films had a storage modulus at 25° C. of 2.8×10⁸ Pa and a storage modulus at 100° C. of 2.3×10⁶ Pa.

Then, the acrylic-based pressure-sensitive adhesive prepared in Example III-1 was coated on the flexible polyvinyl chloride film in the same manner as in Comparative Example III-1 to form a pressure-sensitive adhesive layer to prepare a pressure-sensitive adhesive sheet.

### Comparative Example III-4

Mixture 3 composed of the urethane polymer and the acrylic-based monomer obtained in Synthesis Example 3 was coated on a polyester sheet (release sheet) to form sheets composed of a composite film having a thickness of 50 μm, 100 μm or 150 μm.

Then, a blend of 78 parts of ethyl acrylate, 100 parts of butyl acrylate, and 40 parts of 2-hydroxyethyl acrylate was copolymerized in a toluene solution to obtain an acrylic-based copolymer having a number average molecular weight of 300,000. Subsequently, the acrylic-based copolymer was subjected to an addition reaction with 43 parts of 2-methacryloyloxyethyl isocyanate to introduce carbon-to-carbon double bonds in the molecular chain. Further, a mixture of 1 part of a polyisocyanate crosslinking agent and 3 parts of an acetophenones-based photopolymerization initiator per 100 parts of the obtained polymer (the acrylic-based pressure-sensitive adhesive prepared in Example III-1) was coated on one surface of the multi-layer sheet to form a 30-μm thick pressure-sensitive adhesive layer, thereby preparing a pressure-sensitive adhesive sheet.

### Example III-4

As first films were provided three kinds of PET films having different thicknesses, i.e., 50 μm, 100 μm and 150 μm as shown in Table 4. The PET films had a storage modulus at 25° C. of 7.2×10⁹ Pa. On one surface of each PET film was coated Mixture 4 composed of the urethane polymer and acrylic-based monomer obtained in Synthetic Example 4 to a thickness after curing of 50 μm, 100 μm or 150 μm as shown in Table 4 and cured by irradiating ultraviolet rays (illuminance: 163 mW/cm²; quantity of light: 2,100 mJ/cm²) by using a high-pressure mercury lamp to cure the coating to form a composite film on the PET film to prepare a support having a layer structure of first film/composite film.

Then, a blend of 78 parts of ethyl acrylate, 100 parts of butyl acrylate, and 40 parts of 2-hydroxyethyl acrylate was copolymerized in a toluene solution to obtain an acrylic-based copolymer having a number average molecular weight of 300,000. Subsequently, the acrylic-based copolymer was subjected to an addition reaction with 43 parts of 2-methacryloyloxyethyl isocyanate to introduce carbon-to-carbon double bonds in the molecular side chain. Further, a mixture of 1 part of a polyisocyanate crosslinking agent and 3 parts of an acetophenones-based photopolymerization initiator per 100 parts of the obtained polymer was coated on one surface of the multi-layer sheet to form a 30-μm thick pressure-sensitive adhesive layer, thereby preparing a pressure-sensitive adhesive sheet.

<Evaluation Tests>

The pressure-sensitive adhesive sheets obtained in Examples III-1 to III-4 and Comparative Examples III-1 to III-4 were evaluated.

That is, first, twenty 8-inch wafers each having a thickness of 625 μm were provided and the pressure-sensitive adhesive sheets obtained as described above were bonded thereto by using “DR-8500III” manufactured by Nitto Seiki co., Ltd. The laminates were polished by using a silicon wafer-polishing machine manufactured by Disko Co., Ltd. to a thickness of 50 μm. The results of the evaluation tests are shown in Table 3 or 4. The respective pressure-sensitive adhesive sheets were measured of flexural moduli. The results are also shown in Table 3 or 4.

(1) Evaluation of Curl

A silicon wafer after polishing to a thickness of up to 50 μm of which the pressure-sensitive adhesive sheet remained to be bonded thereto was placed stationary on a plate with its pressure-sensitive adhesive sheet side up. Then, the distance between points at which the height of the wafer became maximal was measured as a curl. In this case, the curl was indicated in terms of an average of 20 wafers.

(2) Evaluation of Sag

A silicon wafer after polishing wafers still having pressure-sensitive adhesive sheet was housed in a 6-inch wafer-housing cassette with the wafer side up. For the bent silicon wafers due to self-weight, a distance between the highest part and the sagging lowest part of the wafer was defined as a sag amount. A wafer having a sag amount of less than 10 mm was indicated by a symbol “◯”, a wafer having a sag amount of 10 mm or more and less than 20 mm was indicated by a symbol “Δ”, and a wafer having a sag amount of more than 20 mm was indicated by a symbol “X”.

(3) Breakage of Wafers

Number of wafers in which cracks occurred during the polishing was counted.

(4) Presence or Absence of Penetration of Water

Silicon wafers after polishing were released from pressure-sensitive adhesive sheets and the surface of each silicon wafer on which the pressure-sensitive adhesive sheet was bonded was observed under optical microscopes (two types; one with a magnification of 100 times and another with a magnification of 200 times). A case where penetration of water was observed even only one wafer out of 20 wafers was indicated that penetration of water was “present” and a case in where penetration of water was observed in none of the wafers was indicated that penetration of water was “absent”.

TABLE 3

| | | | | | | |
|---|---|---|---|---|---|---|
| | Compo- | | | | | Pene- |
| First | site | Flexural | | | Wafer | tration |
| Film | Film | Modulus | Curl | | Breakage | of |
| (μm) | (μm) | (N/mm²) | (mm) | Sag | (Number) | Water |

Example
III-1

| | | | | | | |
|---|---|---|---|---|---|---|
| 50 | 50 | 56.2 | 5 | Δ | 0 | Absent |
| | 100 | 34.8 | 4 | Δ | 0 | Absent |
| | 150 | 14.5 | 3 | Δ | 0 | Absent |
| 100 | 50 | 57.5 | 3 | ◯ | 0 | Absent |
| | 100 | 30.5 | 2 | ◯ | 0 | Absent |
| | 150 | 19.3 | 3 | ◯ | 0 | Absent |
| 150 | 50 | 42.1 | 2 | ◯ | 0 | Absent |
| | 100 | 25.3 | 1 | ◯ | 0 | Absent |
| | 150 | 17.4 | 1 | ◯ | 0 | Absent |

Example
III-2

| | | | | | | |
|---|---|---|---|---|---|---|
| 50 | 50 | 84.4 | 5 | Δ | 0 | Absent |
| | 100 | 27.2 | 5 | ◯ | 0 | Absent |
| | 150 | 20.3 | 3 | ◯ | 0 | Absent |
| 100 | 50 | 166.5 | 3 | ◯ | 0 | Absent |
| | 100 | 83.4 | 3 | ◯ | 0 | Absent |
| | 150 | 48.6 | 2 | ◯ | 0 | Absent |
| 150 | 50 | 122.6 | 1 | ◯ | 0 | Absent |
| | 100 | 69.6 | 1 | ◯ | 0 | Absent |
| | 150 | 45.4 | 0 | ◯ | 0 | Absent |

Example
III-3

| | | | | | | |
|---|---|---|---|---|---|---|
| 50 | 50 | 48.2 | 4 | Δ | 0 | Absent |
| | 100 | 19.7 | 4 | ◯ | 0 | Absent |
| | 150 | 11.6 | 3 | ◯ | 0 | Absent |
| 100 | 50 | 104.4 | 4 | ◯ | 0 | Absent |
| | 100 | 56.6 | 2 | ◯ | 0 | Absent |
| | 150 | 34.6 | 2 | ◯ | 0 | Absent |
| 150 | 50 | 105.9 | 0 | ◯ | 0 | Absent |
| | 100 | 61.1 | 0 | ◯ | 0 | Absent |
| | 150 | 40.3 | 0 | ◯ | 0 | Absent |

TABLE 4

| | | | | | | |
|---|---|---|---|---|---|---|
| | Compo- | | | | | Pene- |
| First | site | Flexural | | | Wafer | tration |
| Film | Film | Modulus | Curl | | Breakage | of |
| (μm) | (μm) | (N/mm²) | (mm) | Sag | (Number) | Water |

Compar-
ative
Example
III-1

| | | | | | | |
|---|---|---|---|---|---|---|
| 50 | — | 172.4 | 10 | Δ | 11 | Present |
| 100 | | 269.2 | 7 | ◯ | 15 | Present |
| 150 | | 216.2 | 5 | ◯ | 14 | Present |

Compar-
ative
Example
III-2

| | | | | | | |
|---|---|---|---|---|---|---|
| 50 | — | 34.5 | 28 | X | 2 | Absent |
| 100 | | 16.1 | 14 | X | 1 | Absent |
| 150 | | 15.1 | 10 | X | 1 | Absent |

Compar-
ative
Example
III-3

| | | | | | | |
|---|---|---|---|---|---|---|
| 50 | 50 | 48.2 | 5 | Δ | 8 | Absent |
| | 100 | 21.2 | 3 | ◯ | 9 | Absent |
| | 150 | 13.1 | 2 | ◯ | 9 | Absent |
| 100 | 50 | 118.0 | 2 | ◯ | 9 | Absent |
| | 100 | 62.4 | 1 | ◯ | 10 | Absent |
| | 150 | 37.4 | 1 | ◯ | 12 | Absent |
| 150 | 50 | 112.4 | 0 | ◯ | 13 | Present |
| | 100 | 65.9 | 0 | ◯ | 11 | Absent |
| | 150 | 41.8 | 0 | ◯ | 12 | Absent |

Compar-
ative
Example
III-4

| | | | | | | |
|---|---|---|---|---|---|---|
| — | 50 | 17.2 | 30 | X | 2 | Absent |
| | 100 | 8.0 | 24 | X | 2 | Absent |
| | 150 | 6.1 | 17 | X | 1 | Absent |

Example
III-4

| | | | | | | |
|---|---|---|---|---|---|---|
| 50 | 50 | 40.2 | 8 | Δ | 3 | Absent |
| | 100 | 16.6 | 8 | Δ | 4 | Absent |
| | 150 | 9.4 | 7 | ◯ | 3 | Absent |
| 100 | 50 | 102.9 | 5 | ◯ | 4 | Absent |
| | 100 | 50.1 | 4 | ◯ | 4 | Absent |
| | 150 | 28.5 | 4 | ◯ | 3 | Absent |
| 150 | 50 | 104.5 | 3 | ◯ | 6 | Absent |
| | 100 | 58.7 | 3 | ◯ | 4 | Absent |
| | 150 | 36.3 | 3 | ◯ | 3 | Absent |

As will be apparent from Tables 3 and 4, silicon wafers processed by using the pressure-sensitive adhesive sheets of Examples III-1 to III-3 of the present invention that are pressure-sensitive adhesive sheets having a composite film and a film made of a material different from the material of the composite film in which the composite film has a storage modulus at 25° C. of less than 2.0×10⁸ Pa and a storage modulus at 100° C. of 3.0×10⁵ Pa or more and in which the first film has a storage modulus at 25° C. of 2.0×10⁸ Pa or more have curls of 5 mm or less and sags of less than 20 mm. When these wafers were polished to a thickness of 50 μm, none of them showed cracks (wafer breakage ratio: 0%). Note that the silicon wafers processed by using the pressure-sensitive adhesive sheet of Example III-4 in which the composite film has a storage modulus at 100° C. of less than 3.0×10⁵ Pa showed no penetration of water and had a curl of 8 mm or less and a sag of less than 10 mm as well as a wafer breakage number during polishing of 3 to 6 (wafer breakage ratio: 30% or less). Here, comparison between Examples III-1 to III-3 and Example III-4 indicates that the pressure-sensitive adhesive sheet in which the composite film has a storage modulus at 25° C. of less than 2.0×10⁸ Pa and a storage modulus at 100° C. of 3.0×10⁵ Pa or more and in which the first film has a storage modulus at 25° C. of 2.0×10⁸ Pa or more enables processing without causing breakage of even a single wafer.

On the other hand, as will be apparent from Table 4, when silicon wafers were processed into thin films by using the pressure-sensitive adhesive sheets of Comparative Examples III-1 and III-3, eight or more wafers suffered breakage (wafer breakage ratio: 40% or more). On the other hand, in the case of the pressure-sensitive adhesive sheets of Comparative Examples III-2 and III-4 in which one of the composite film and the first film was absent, the silicon wafers had a large curl and large sag. Therefore, they had defects in evaluations of at least one of curl, sag and wafer breakage.

As described in detail in the foregoing, according to the present invention, optimal numerical ranges of flexural modulus, storage modulus and so forth of pressure-sensitive adhesive sheets for processing precision parts and other articles can be recognized. Use of a support having a composite film containing a urethane polymer and a vinyl-based polymer as effective components makes it easy to adjust the characteristics of a pressure-sensitive adhesive sheet, such as flexural modulus and storage modulus. Further, presence of a composite film in the pressure-sensitive adhesive sheet allows adopting a multi-layer construction of the pressure-sensitive adhesive sheet. Further, use of a composite film enables formation of a satisfactory laminate without using solvents such as methyl ethyl ketone, so that no environmental pollution arises.

According to the present invention, there are provided a pressure-sensitive adhesive sheet that prevents the breakage and contaminations of products such as semiconductor products and optical products when the products are processed and that prevents occurrence of an unacceptable sag or curl and a method of producing such pressure-sensitive adhesive sheets as well as multi-layer sheets suitable for use in such pressure-sensitive adhesive sheets. For example, polishing such semiconductor wafers after application of the pressure-sensitive adhesive sheet of the present invention to thin semiconductor wafers can reduce number of broken wafers. Further, use of the pressure-sensitive adhesive sheets of the present invention can cause less sag in the semiconductor wafers and reduce the curl of the semiconductor wafers due to the residual stress of the pressure-sensitive adhesive sheet, so that the semiconductor wafers can be housed in a specifically designed housing case. As a result, there occurs no harm in transportation or other operations.

Polishing performed by using the pressure-sensitive adhesive sheets of the present invention causes no breakage of wafers when a pressure-sensitive weakly adhesive sheet (sheet for releasing) is applied to the pressure-sensitive adhesive sheet after the polishing of the wafer and the pressure-sensitive weakly adhesive sheet is pulled to peel the pressure-sensitive adhesive sheet from the wafer.

The present invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A pressure-sensitive adhesive sheet comprising a composite film comprised by a composition containing a urethane polymer and a vinyl polymer as effective components, a first film comprising a material different from that of the composite film, and a pressure-sensitive adhesive layer, wherein the pressure-sensitive adhesive sheet has a modulus of 9 N/mm² or more and 250 N/mm² or less when an oblong piece of the pressure-sensitive adhesive sheet with a width of 20 mm is bent at a radius of curvature of 3.0 mm.

2. The pressure-sensitive adhesive sheet as claimed in claim 1, wherein the pressure-sensitive adhesive sheet has a modulus of 15 N/mm² or more and 250 N/mm² or less when an oblong piece of the pressure-sensitive adhesive sheet with a width of 20 mm is bent at a radius of curvature of 3.0 mm.

3. The pressure-sensitive adhesive sheet as claimed in claim 1, wherein the vinyl polymer is an acrylic polymer.

4. The pressure-sensitive adhesive sheet as claimed in claim 1, wherein the composite film comprises a film obtained by reacting a polyol and a polyisocyanate in a radical polymerizable monomer to form a urethane polymer, coating a mixture of the urethane polymer and the radical polymerizable monomer on the first layer and irradiating a radiation onto the coating to cure it.

5. The pressure-sensitive adhesive sheet as claimed in claim 4, wherein the radical polymerizable monomer is an acrylic monomer.

6. The pressure-sensitive adhesive sheet as claimed in claim 1, wherein the composite film has a storage modulus at 25° C. of less than 2.0×10⁸ Pa and a storage modulus at 100° C. of 3.0×10⁵ Pa or more.

7. The pressure-sensitive adhesive sheet as claimed in claim 6, wherein the first film has a storage modulus at 25° C. of 2.0×10⁸ Pa or more.

8. The pressure-sensitive adhesive sheet as claimed in claim 7, wherein the first film has a thickness (t1) of 10 μm or more and 200 μm or less and the composite film has a thickness (t2) of 10 μm or more and 300 μm or less, and wherein a ratio of the thicknesses (t1/t2) is t1/t2=0.1 to 10.

9. The pressure-sensitive adhesive sheet as claimed in claim 1, wherein pressure-sensitive adhesive sheet comprises the first film on one side of the composite film and a second film on the other side of the composite film.

10. The pressure-sensitive adhesive sheet as claimed in claim 1, wherein the first film has a thickness (t1) of 10 μm or more and 200 μm or less and the composite film has a thickness (t2) of 10 μm or more and 300 μm or less, and wherein a ratio of the thicknesses (t1/t2) is t1/t2=0.1 to 10.

11. A multi-player sheet for use for a pressure-sensitive adhesive sheet, comprising a composite film comprised by a composition containing a urethane polymer and a vinyl polymer as effective components, and a first film comprising a material different from that of the composite film, wherein the pressure-sensitive adhesive sheet has a modulus of 9 N/mm² or more and 250 N/mm² or less when an oblong piece of the pressure-sensitive adhesive sheet with a width of 20 mm is bent at a radius of curvature of 3.0 mm.

12. The multi-layer sheet as claimed in claim 11, wherein the multi-layer sheet comprises the first film on one side of the composite film and a second film on the other side of the composite film.

13. A method of producing a pressure-sensitive adhesive sheet, comprising coating a mixture containing a urethane polymer and a radiation polymerizable monomer on a first film, irradiating a radiation onto the coating to cure it to form a composite film, and forming a pressure-sensitive adhesive layer on the composite film.

14. The method of producing a pressure-sensitive adhesive sheet as claimed in claim 13, wherein the mixture is produced by reacting a polyol and a polyisocyanate in the radical polymerizable monomer to form a urethane polymer.

15. A method of producing a multi-layer sheet, comprising coating a mixture of a urethane polymer and a radical polymerizable monomer on a first film and irradiating a radiation onto the coating to cure it to form a composite film.

16. The method of producing a multi-layer sheet as claimed in claim 15, wherein after the mixture is coated on the first film, a second film is overlaid thereon and the radiation is irradiated above the second film to cure the coating to form a composite film, thereby forming a multi-layer sheet having the first film, the composite film and the second film.

17. The method of producing a multi-layer sheet as claimed in claim 15, wherein the mixture is produced by reacting a polyol and a polyisocyanate in the radical polymerizable monomer to form a urethane polymer.

18. The method of producing a multi-layer sheet as claimed in claim 15, wherein the method comprises reacting a polyol and a polyisocyanate in the radical polymerizable monomer to form a urethane polymer, coating a mixture containing the urethane polymer and the radical polymerizable monomer on a base material, irradiating a radiation onto the coating to cure it to form on one side of the first layer a composite film having a storage modulus at 25° C. of less than 2.0×10⁸ Pa and a storage modulus at 100° C. of 3.0×10⁵ Pa or more.

19. A method of processing a product, comprising applying a pressure-sensitive adhesive sheet to a product to be precision processed and conducting precision processing of the product in a held and/or protected state, wherein the pressure-sensitive adhesive sheet comprising a composite film comprised by a composition containing a urethane polymer and a vinyl polymer as effective components, and a first film comprising a material different from that of the composite film, the pressure-sensitive adhesive sheet having a modulus of 9 N/mm² or more and 250 N/mm² or less when an oblong piece of the pressure-sensitive adhesive sheet with a width of 20 mm is bent at a radius of curvature of 3.0 mm.
